(19) United States
(12) Patent Application Publication
(10) Pub. No.: US 2016/0035025 A1
(43) Pub. Date: Feb. 4, 2016

(54) Process for Creating a Social Network through Which Private Securities Transactions Using General Solicitations are Electronically Created and Settled in Compliance with the U.S. Securities Act of 1933

(71) Applicant: Jarvis Jerome Lagman, Flushing, NY (US)

(72) Inventor: Jarvis Jerome Lagman, Flushing, NY (US)

(21) Appl. No.: 14/446,341

(22) Filed: Jul. 30, 2014

(51) Int. Cl. G06Q 40/04; G06Q 30/02; G06Q 50/00; G06Q 30/00; G06Q 50/26

(52) U.S. Cl. CPC G06Q 40/04; G06Q 30/018; G06Q 30/0255; G06Q 50/265; G06Q 50/01

(57) ABSTRACT

The present invention is a process for creating a social network through which private securities transactions using general solicitation are electronically created and settled in compliance with the U.S. Securities Act of 1933 whereby data regarding the securities industry is uploaded, stored, aggregated, processed and circulated, general solicitations regarding private offerings of securities are electronically disseminated and private securities transactions are electronically documented, authorized and settled. The present invention introduces a novel and useful process whereby technology is used to serve as a functional surrogate in the role traditionally played by broker-dealers in the creation of private securities transactions, increase the accessibility of private securities offerings using general solicitation, lower transactions costs and risks associated with the documentation, authorization and settlement of private securities transactions, facilitate compliance with federal securities laws and improve electronic channels of communication between investors, issuers, broker-dealers and other participants in the private securities industry.

### CROSS-REFERENCE TO RELATED INVENTIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The process contemplated by the present invention is a method and system of: (i) automating the creation and settlement of private securities transactions in compliance with U.S. federal securities laws; (ii) electronically identifying and providing the means for verifying that potential purchasing investors qualify as Accredited Investors; and (iii) developing an online social network specifically designed to facilitate the dissemination of information regarding private securities offerings and participants in the securities industry, enhance communication between participants in the securities industry and provide users increased flexibility in organizing data regarding the private securities industry. The preferred embodiment of the present invention is a website on the internet or a web application comprised of a publicly accessible social network of technological forums through which data regarding participants in the securities industry are uploaded, aggregated, processed and circulated, general solicitations regarding private offerings to purchase or sell securities are electronically disseminated and private securities transactions are electronically documented, authorized and settled. The process introduced by the system and method contemplated by the present invention involves the application of mass communication technology, data tagging and aggregation processes and social networking technology to the field of the automation of securities transactions and the electronic dissemination of information regarding the securities industry in a manner not previously suggested or contemplated by others.

Transactions in securities in the United States are largely regulated by the United States Securities and Exchange Commission (“SEC”) and are governed by the United States Securities Act of 1933 (“Securities Act”). Under the Securities Act, any offer to sell securities must either be registered with the SEC or qualify for an exemption from registration. Regulation D of the Securities Act (“Regulation D”) is an exemption that allows qualifying companies to offer and sell their securities without registering the subject securities with the SEC. Regulation D contains three rules providing exemptions from the registration requirements, known as Rule 504, Rule 505 and Rule 506, which allow some companies to offer and sell their securities without having to register the securities with the SEC.

The method and system contemplated by the present invention primarily relies upon the exemption from registration set forth under Rule 506(c) of Regulation D (“Rule 506(c)”), which was recently enacted on Sep. 23, 2013 and permits the use of general solicitations in connection with private offerings to sell securities if the issuer took reasonable steps to verify that the purchaser qualifies as an “Accredited Investor,” as defined in Regulation D of the Securities Act. Prior to the enactment of Rule 506(c), issuers and broker-dealers were prohibited from using general solicitations in connection with private offerings to sell securities. However, Rule 506(c) altered the regulatory scheme to permit the use of general solicitations in connection with private offerings to sell securities if the issuer took reasonable steps to verify that the purchaser qualifies as an “Accredited Investor.” In reliance on the newly enacted Rule 506(c), the method and system contemplated by the present invention creates a process for creating an online social network specifically designed to electronically identify and provide the means for verifying that potential purchasing investors qualify as Accredited Investors as well as facilitate the dissemination of information regarding private securities offerings and participants in the securities industry, enhance communication between participants in the securities industry and provide users increased flexibility in organizing data regarding the private securities industry, which was not possible prior to the enactment of Rule 506(c). Further, through the social networking website contemplated as the preferred embodiment of the present invention, general solicitations in connection with private offerings of securities can be used to automatically create and settle private securities transactions in a manner not previously suggested or contemplated by others.

Historically, private offerings to sell securities could not use general solicitation because the use of general solicitation in the creation of such private securities transactions was prohibited prior to the enactment of Rule 506(c). Private securities transactions created prior to the enactment of Rule 506(c) in reliance on Regulation D could only be created if the parties had a “pre-existing relationship.” As a result, broker-dealers had played a significant role in the creation of private securities transactions, typically as placement agents or underwriters of an issuer. The functionality of broker-dealers in the creation of private securities transactions derives from the extensive rolodex of Accredited Investors with whom such broker-dealers have had a pre-existing relationship. By engaging a broker-dealer to serve as its placement agent or underwriter, an issuer is able to create private securities transactions by tapping into pools of capital provided by those certain Accredited Investors with whom such broker-dealers have a pre-existing relationship.

Because the newly enacted Rule 506(c), under certain circumstances, eliminates the requirement that parties to a private securities transactions have a pre-existing relationship, the system and method contemplated by the present invention reduces the need for broker-dealers by allowing prospective sellers and prospective purchasers of securities to communicate directly with each other by utilizing social networking technology to serve as a functional surrogate in the role traditionally played by such broker-dealers. Further, the present invention also increases the number of private securities offerings accessible to the public through the use of mass communications technology to disseminate general solicitations about such offerings electronically though the internet using the present invention. The present invention also lowers transactions costs associated with the creation of private securities transactions by streamlining and automating the process by which such transactions are documented, authorized and settled. Additionally, the present invention strengthens relationships between investors, issuers and other users and improves the quality of the marketplace of ideas by forming a social network through which new channels of communication between such users are created and data regarding such users and the securities industry, in general, is aggregated, organized and circulated.

### Traditional Barriers to Access to Capital Markets

Historically, with regard to companies seeking capital, access to capital has been limited to those with access to informal networks of friends, family, wealthy individuals, and classic venture capital resources, such as registered broker-dealers, investment banks and financial advisors. With regard to investors, access to potential private investment opportunities, as a result of minimal networking opportunities and limitations imposed by state and federal securities regulation, has traditionally been limited to high net worth or high income Accredited Investors. As defined by the United States Securities and Exchange Commission (the “SEC”), with respect to individual investors, individual investors who qualify as Accredited Investors must meet at least one of the following criteria: a net worth of at least $1 million either individually or jointly with the investor's spouse, an individual income of $200,000 for at least the last two years, and a joint income of at least $300,000 a year for at least the last two years. There are also additional qualifications for institutional investors to qualify as Accredited Investors. Most private securities offerings are undertaken in reliance from the exemption from federal securities registration requirements provided in SEC Rule 506 of Regulation D of the Securities Act of 1933 (the “Securities Act”).

The underlying rationale for the exemption from federal securities registration requirements was first articulated by the United States Supreme Court in the seminal securities law case SEC v. Ralston Purina: “The natural way to interpret the private offering exemption is in light of the statutory purpose. Since exempt transactions are those as to which ‘there is no practical need for [the Securities Act's] application, the applicability of [the exemption provided by Section 4(2) of the Securities Act, the statutory provision upon which Rule 506 is founded], should turn on whether the particular class of persons affected need the protection of the [Securities] Act. An offering to those who are shown to be able to fend for themselves is a transaction ‘not involving any public offering.’” See SEC v. Ralston Purina, 346 US 119, 125 (1953). In response, the SEC created a class of investors defined as Accredited Investors to set forth the criteria for determining who qualifies for that certain class of investors “who are shown to be able to fend for themselves.” As a result of Ralston Purina and its progeny, offerings of securities to “accredited investors” are accorded special treatment under the Securities Act and, consequently, have more options in their ability to purchase securities.

Currently, most privately-placed securities offerings in the United States, and virtually all privately-placed securities offerings undertaken through the United States' private equities market as it currently exists, are undertaken in reliance on “Prior Rule 506,” which is defined herein as exemptions for registration of securities under Rule 506 of Regulation D other than Rule 506(c). Offerings under Prior Rule 506 offerings are distinguished from offerings under Rule 506(c) because Prior Rule 506 offerings: (i) cannot use general solicitation in marketing the securities offered; and (ii) can only be made to potential investors with whom either the company issuing securities or the broker-dealer undertaking the securities offering has a “pre-existing relationship” (collectively the “Prior Rule 506 Prohibitions”).

Because of the Prior Rule 506 Prohibitions, the current private securities market denies potential investors who would elect to enter into securities transactions under Rule 506 (the “Denied Potential Investors”) from entering into such transactions because the limitation on the availability of information regarding such offerings inhibits the ability of Denied Potential Investors to participate in such offerings. The use of general solicitation, as permitted by Rule 506(c) and as contemplated by the present invention, would enable such Denied Potential Investors to participate in Rule 506 offerings in a manner that is not possible under the Prior Rule 506 regulatory scheme. Further, because of the Prior Rule 506 Prohibitions, issuers of securities in the current private securities market are limited in their ability to raise capital because the pool of potential investors in their Prior Rule 506 offerings of securities is diminished by the inability for the Denied Potential Investors to participate in such offerings. This limitation on the ability for issuers to raise capital from such Denied Potential Investors has greater negative consequences on the economy at large, since such issuers generally use such capital to expand and/or fund their operations, purchase infrastructure, satisfy debts, hire workers, make investments and to further other such permissible business purposes.

Because of the Prior Rule 506 Prohibitions, the duration of time necessary to create securities transactions under Prior Rule 506 offerings is significantly longer than the duration of time necessary to create securities transactions under Rule 506(c) offerings. Prior Rule 506 securities offerings can be undertaken on the internet only if they are conducted in password protected offerings directed to password holders with whom the Issuer or the Broker-Dealer has a “pre-existing substantive relationship.” Under Prior Rule 506, such a pre-existing substantive relationship could be established by asking a series of questions regarding an investor's assets, income, investment experience, etc. Such questions are usually asked in the form of a written (or online) questionnaire. Further, sufficient time must have elapsed between a respondent's completion of the questionnaire and the contemplation or inception of a particular securities offering undertaken in reliance on regulatory exemptions such as Rule 506 which prohibit general solicitation. Numerous No-Action Letters issued by the United States Securities and Exchange Commission prior to the advent of online private placements of securities have established the parameters governing this principal. See, e.g., Bateman Eichler Hill Richards, Incorporated, 1985 SEC No-Act. LEXIS 2918 (Dec. 3, 1985), H.B. Shaine & Co., Inc., 1987 SEC No-Act. LEXIS 2004 (May 1, 1987), Woodtrails-Seattle, Ltd., 1982 SEC No-Act. LEXIS 2662 (Aug. 9, 1982), and E.F. Hutton & Co., 1985 SEC No-Act. LEXIS 2917 (Dec. 3, 1985).

Because of the “pre-existing substantive relationship requirement” described above, which requires a lapse between a potential investor's completion of an investor questionnaire and that investor's participation in a securities offering, the current private equities market causes issuers and broker-dealers to deny potential investors access to securities offerings being undertaken by such issuers and broker-dealers at the time the potential investors complete and submit the investor questionnaire. Instead, potential investors must fill out an online investor questionnaire and wait until a later time to review potential private investments in a two-step process that is not well suited to the instantaneous settlement of transactions typically expected by Internet users. This two-step delay is a hindrance to issuers and broker-dealers seeking to raise capital. Alternatively, the duration of time necessary to create securities transactions under Rule 506(c) offerings is shorter in comparison to Prior Rule 506 offerings because the abolishment of the Prior Rule 506 Prohibitions provided by Rule 506(c) eliminated the “time lapse requirement” between a respondent's completion of the questionnaire and the contemplation or inception of a particular securities offering undertaken in reliance on regulatory exemptions such as Prior Rule 506.

In addition, potential investors seeking to participate in the current private securities market face either difficulty or impossibility in achieving diversification in their investment holdings. It is difficult for investors participating in the current private equities market to diversify their holdings because the Prior Rule 506 Prohibitions limit the degree of information generally available in connection with Prior Rule 506 offerings and prohibit the creation of securities transactions under Prior Rule 506 offerings unless the potential investor had a “pre-existing relationship” with the issuer or the broker-dealer undertaking the securities offering. The abolishment of the Prior Rule 506 Prohibitions under Rule 506(c) promotes diversification because it expands the degree of information publicly available with regard to Rule 506(c) offerings and permits investors to participate in the creation of a broader range of securities transactions arising from Rule 506(c) offerings because there is no requirement under Rule 506(c) that a potential investor have a “pre-existing relationship” with the issuer or the broker-dealer undertaking the securities offering. As a result, the method and system contemplated by the current invention is novel and improves the Current Private Securities Market by utilizing technological processes to expand the degree of information publicly available with regard to Rule 506(c) offerings by making such information available in a publicly accessible centralized forum and by enhancing the organization of such information by allowing potential investors to re-arrange such information on the basis of tags; and permit investors to participate in the creation of a broader range of securities transactions arising from Rule 506(c) offerings by allowing investors and Issuers to review Offering materials, authorize documents and disburse funds and securities through the use of the Internet.

Further, under the prevailing practice of the current private securities market, broker-dealers wield significant power in granting access to such markets. Broker-dealers typically do not offer securities on behalf of issuers seeking “seed or first round financings,” but instead offer securities of those issuers past the seed or first round stage which seek expansion financing rather than start-up funds. The first $1 million in private financing that an issuer raises is typically the most difficult to secure, and the current private securities market is not well-suited to seed and first round financings. In particular, the current private securities market is not well-suited to assist early stage issuers in capital formation because broker-dealers are not willing to assume the risk of marketing an offering to raise money in connection with a company or invention that has not yet been proven to be commercially or financially viable. The present invention, through its reliance on Rule 506(c), promotes the probability that “seed or first round financings” would receive funding since the increased availability of information regarding such issuers who use the present invention enables such issuers to increase public awareness about the potential utility in making an investment in such issuer. Ultimately, potential investors may have a greater tolerance for assuming more risk in connection with their choice of investments than broker-dealers, but are limited in their access to a broader range of investment opportunities because broker-dealers, who have historically been the medium through which investors and companies seeking to raise capital through equity financing are introduced for the purpose of creating private securities transactions, do not make such investment opportunities available. As a result, the method and system contemplated by the present invention is novel and improves the current private securities market applying the newly enacted Rule 506(c) to create a method and system that uses technological processes to replace the role that Broker-Dealers have played in granting access to capital markets, which would allow potential investors to assess the risks and benefits of investing in certain Issuers without interference or censorship by such broker-dealers and would allow issuers to expose their offerings to potential investors without risk of interference of broker-dealers in diminishing the exposure of such offerings.

### Rule 506(c) of Regulation D of the Securities Act of 1933

Every offering of securities undertaken in the United States must either be registered with the SEC and all applicable state securities administrators, or alternatively, be undertaken pursuant to statutes and regulations which exempt the offering from federal and state securities registration requirements. Without registration or an appropriate exemption from registration requirements, investors have a statutory rescission right to a return of their investment with interest.

Rule 506(c) was made effective by the Securities Exchange Commission on Sep. 23, 2013 pursuant to the requirements of the Jumpstart Our Business Startups Act (“JOBS Act”). Rule 506(c) enables issuers of securities to use general solicitation in offerings of securities if certain requirements are met. The enactment of Rule 506(c) changed the regulatory landscape governing offerings of securities because, under Prior Rule, the use of general solicitation in an offering of securities was largely prohibited.

Generally, Rule 506 of Regulation D of the Securities Act (“Rule 506”) offers three primary advantages as compared to the exemptions provided by Rule 504 and SEC Rule 505, the two remaining exemptions contained in the SEC's Regulation D (other than Rule 506(c), which was only recently enacted). First, there is no dollar limit on the aggregate sales price of securities that can be sold pursuant to Rule 506, while SEC Rules 504 and 505 limit the aggregate sales price received by the company issuing securities to $1 million and $5 million, respectively. Second, SEC Rule 506, unlike SEC Rules 504 or 505, not only exempts securities offerings from federal securities registration requirements, but also has the additional benefit, by virtue of the National Securities Markets Improvement Act of 1996, of pre-empting state securities registration requirements and other regulation such that state securities administrators can require nothing more than a copy of the “Form D” notice filing made with the SEC, the payment of a state filing fee, and a consent to service of process. Third, by limiting Rule 506 offerings to Accredited Investors, companies or broker-dealers undertaking securities offerings can do so without the extensive information disclosure requirements (e.g., without a full-fledged private placement memorandum) applicable to soliciting investments from “non-accredited” investors. While Rule 506 generally offers the advantages of having no limit on the amount of securities that can be sold, pre-empting state securities laws, and, when securities offerings are directed solely to Accredited Investors, its use also imposes certain limitations. The securities acquired by investors in Rule 506 offerings are “restricted” securities, which generally cannot be resold by non-affiliated investors, pursuant to SEC Rule 144(k), until such investors have held the securities for a specified holding period.

Offerings under Prior Rule 506 are prohibited from using general solicitation and could only be made to potential investors with whom either the company issuing securities or the broker-dealer undertaking the securities offering has a “pre-existing relationship.” The enactment of Rule 506(c) lifted the prohibition on general solicitation and the “pre-existing relationship” requirement and allows issuers to use general solicitation in the offering of securities, and enjoy all of the benefits of Rule 506 as set forth above, if the issuer complies with the requirements of Rule 506(c), as set forth supra.

Enacted in 2012, the JOBS Act was intended, among other things, to reduce barriers to capital formation, particularly for smaller companies. The JOBS Act required the SEC to adopt rules amending existing exemptions from registration under the Securities Act of 1933 and created new exemptions that permit issuers of securities to raise capital without SEC registration. On Jul. 10, 2013, the SEC adopted amendments to Rule 506 of Regulation D and Rule 144A under the Securities Act to implement the requirements of Section 201(a) of the JOBS Act. The amendments were effective on Sep. 23, 2013. The formal rule amendment can be found in SEC Release No. 33-9415 entitled “Eliminating the Prohibition Against General Solicitation and General Advertising in Rule 506 and Rule 144A Offerings.”

Generally, Section 4(a)(2) of the Securities Act exempts from registration “transactions by an issuer not involving any public offering.” Under Prior Rule 506, an issuer was prohibited from using general solicitation to market the securities. “General Solicitation” includes but is not limited to advertisements published in newspapers and magazines, public websites, communications broadcasted over television and radio, and seminars where attendees have been invited by general solicitation or general advertising. In addition, the use of an unrestricted, and therefore publicly available, website constitutes general solicitation. The solicitation must be an “offer” of securities, but solicitations that condition the market for an offering of securities may be considered to be offers.

In contrast, Section 201(a) of the JOBS Act requires the SEC to eliminate the prohibition on using general solicitation under Rule 506 where all purchasers of the securities are accredited investors and the issuer takes reasonable steps to verify that the purchasers are accredited investors. To implement Section 201(a), the SEC adopted paragraph (c) of Rule 506. Under Rule 506(c), issuers can offer securities through means of general solicitation, provided that:
all purchasers in the offering are accredited investors,
the issuer takes reasonable steps to verify their accredited investor status, and
certain other conditions in Regulation D are satisfied, including but not limited to filing a Form D on EDGAR, which is a forum through which the SEC publishes certain public disclosures released by issuers.

The following suitability standards are minimum requirements for prospective investors to qualify as accredited investors under the Securities Act. The term “Accredited Investors” as defined in Rule 501 of Regulation D of the Securities Act means:
A bank as defined in section 3(a)(2) of the Securities Act, or a savings and loan association or other institution as defined in section 3(a)(5)(A) of the Securities Act whether acting in its individual or fiduciary capacity; any broker or dealer registered pursuant to section 15 of the Securities Exchange Act of 1934 (“Exchange Act”); any insurance company as defined in section 2(13) of the Securities Act; any investment company registered under the Investment Company Act of 1940 or a business development company as defined in section 2(a)(48) of that Securities Act; any Small Business Investment Company licensed by the U.S. Small Business Administration under section 301(c) or (d) of the Small Business Investment Act of 1958; any plan established and maintained by a state, its political subdivisions, or any agency or instrumentality of a state or its employees, if such plan has total assets in excess of $5,000,000; any employee benefit plan within the meaning of Title I of the Employee Retirement Income Security Act of 1974, if the investment decision is made by a plan fiduciary, as defined in section 3(21) of such Act, which is either a bank, savings and loan association, insurance company, or registered investment adviser, or if the employee benefit plan has total assets in excess of $5,000,000 or, if a self directed plan, with investment decisions made solely by persons that are accredited investors;
A private business development company as defined in section 202(a)(22) of the Investment Advisers Act of 1940;
Any organization described in Section 501(c)(3) of the Internal Revenue Code, a corporation, a Massachusetts or similar business trust, or a partnership, not formed for the specific purpose of acquiring the securities offered, with total assets in excess of $5,000,000;
Any director, executive officer, or general partner of the issuer of the securities being offered or sold, or any director, executive officer, or general partner of a general partner of that issuer;
Any natural person whose individual net worth, or joint net worth with that person's spouse, at the time of his purchase exceeds $1,000,000 excluding the value of the primary residence of the natural person;
Any natural person who had an individual income in excess of $200,000 in each of the two most recent years or joint income with that person's spouse in excess of $300,000 in each of those years and has a reasonable expectation of reaching the same income level in the current year;
Any trust, with total assets in excess of $5,000,000, not formed for the specific purpose of acquiring the securities offered, whose purchase is directed by a sophisticated person as described in Rule 506(b)(2)(ii) of Regulation D of the Securities Act; and
Any entity in which all of the equity owners are Accredited Investors.

The JOBS Act requires that issuers wishing to engage in general solicitation take “reasonable steps” to verify the accredited investor status of purchasers. Rule 506(c) sets forth a principles-based method of verification which requires an objective determination by the issuer (or those acting on its behalf) as to whether the steps taken are “reasonable” in the context of the particular facts and circumstances of each purchaser and transaction. Among the factors that an issuer should consider under this principles-based method are:
the nature of the purchaser and the type of accredited investor that the purchaser Claims to be;
the amount and type of information that the issuer has about the purchaser; and
the nature of the offering, such as the manner in which the purchaser was solicited to participate in the offering, and the terms of the offering, such as a minimum investment amount.

In addition to this flexible, principles-based method, Rule 506(c) includes a non-exclusive list of verification methods that issuers may use, but are not required to use, when seeking greater certainty that they satisfy the verification requirement with respect to natural person purchasers. This non-exclusive list of verification methods (which outputs shall be hereinafter referred to as the “Accredited Investor Verification Documents”) consists of:
verification based on income, by reviewing copies of any Internal Revenue Service form that reports income, such as Form W-2, Form 1099, Schedule K-1 of Form 1065, and a filed Form 1040;
verification on net worth, by reviewing specific types of documentation dated within the prior three months, such as bank statements, brokerage statements, certificates of deposit, tax assessments and a credit report from at least one of the nationwide consumer reporting agencies, and obtaining a written representation from the investor;
a written confirmation from a registered broker-dealer, an SEC-registered investment adviser, a licensed attorney or a certified public accountant stating that such person or entity has taken reasonable steps to verify that the purchaser is an accredited investor within the last three months and has determined that such purchaser is an accredited investor; and
a method for verifying the accredited investor status of persons who had invested in the issuer's Rule 506(b) offering as an accredited investor before Sep. 23, 2013 and remain investors of the issuer.
   Rule 506(b) remains unchanged following the adoption of Rule 506(c) and continues to be available for issuers that wish to conduct a Rule 506 offering without the use of general solicitation or that do not wish to limit sales of securities in the offering to accredited investors.

Therefore, as a result of the enactment of Rule 506(c), issuers of securities are now permitted to use general solicitation in offers of securities to Accredited Investors and raise unlimited amounts of capital from such Accredited Investors, if they comply with the requirements of Rule 506(c).

### The Current State of the Online Private Securities Market

In December 1996, IPOnet conducted the first Rule 506 securities offering on the Internet. The SEC, recognizing changes in technology and responding to innovation in the marketplace, has recognized and approved of the use of the Internet and online communications to undertake privately-placed securities offerings through the issuance of SEC No-Action Letters and Interpretive Releases. Under Prior Rule 506, such securities offerings may be made in the United States by companies issuing securities directly, by broker-dealers, and by managers of private funds. See “The Expansion of the General Solicitation Rule of the 1933 Act,” Renae Meltzer and Leo Feldman, The Florida Bar Journal, June 1999; “Angels on the Internet: The Elusive Promise of ‘Technological Disintermediation’ for Unregistered Offerings of Securities, Donald C. Langevoort, JSEBL Vol. 2, Summer 1998; “Brave New World? The Impact(s) of the Internet on Modern Securities Regulation, John C. Coffee, Jr., The Business Lawyer, Vol. 52, Number 4, August 1997; “Private Securities Offerings on the Internet,” Michael D. Stovsky, 1996; Lamp Technologies, Inc., SEC No-Action Letter, 1998 SEC No-Act. LEXIS 615, May 29, 1997; Angel Capital Electronic Network, SEC No-Action Letter, Oct. 25, 1996; IPOnet, SEC No-Action Letter, Jul. 26, 1996 (1996 WL 431821 (SEC); 1996 SEC No-Act. LEXIS 642).

Numerous companies have followed IPOnet in undertaking Prior Rule 506 offerings on the Internet. Garage.com Inc. has assisted early stage companies in raising over $200 million through securities offerings directed to its private network of accredited investors. Other companies employing Prior Rule 506 in securities offerings directed to private networks of accredited investors include Offroad Capital Corp., E*Offering Corp. (acquired by Wit Sound View Group, Inc. effective Oct. 16, 2000), Wit Sound Group, Inc., Virtual Wall Street, Inc./Virtual IPO, Inc. (which undertake public offerings, Regulation A Offerings, and, through its “Private Club”, Rule 506 offerings limited to accredited investors), The New York Private Placement Exchange LLC (which undertakes both Rule 506 offerings directed to accredited investors and secondary re-sales of restricted securities pursuant to Rule 144), EarlyBirdCapital.com, Inc./EarlyBirdCapital, Inc. (which acquired Angeltips.com in September 2000), AngelStreet.com, Inc./LBL Securities, Inc., UniversityAngels, Inc., WR Hambrecht+Co., Direct Stock Market, BeaconVentureCapital.com/Beacon Global Advisors (which distributes securities through independent broker-dealers, family offices, private bankers, and institutional investors rather than directly to individual investors), and IPO.com/Herringtown.com. Additional companies and organizations, while not effecting securities transactions themselves, allow investors in their online networks to negotiate directly with early stage companies. These companies and organizations include: SeekingCapital.com, AngelSociety.com, Rule506.com, Seedstage.com, Ace-Net, and Vcapital.com. However, because Rule 506(c) has only been recently enacted (and the prohibition on the use of general solicitation in connection with the private offering of securities has only been recently lifted), methods and systems for creating securities transactions using general solicitation designed specifically to comply with Rule 506(c), except as contemplated by the present invention, have not yet been invented.

In addition to the use of general solicitation in connection with private offerings of securities and the implementation of an electronic means for automatically creating securities transactions as contemplated by such offerings, the present invention also broadens public access to information regarding participants in the private securities industry by allowing users of the present invention to broadcast biographical data, information regarding preferences, securities holdings and other information which would specifically serve to enhance the quality and quantity of information about the private securities marketplace and participants therein. The website contemplated as the preferred embodiment of the present invention is a unique amalgam in that it synthesizes the data sharing, channels of communication and online community enabled by social networking mass communications technology, similar to the social networks underlying the Facebook and Linked-In websites, with the ability to conduct transactions electronically through the internet, similar to the electronic transactions enabled through the E-Bay, E-Trade, Scottrade and Kickstarter websites. However, the preferred embodiment of the present invention significantly differs from these websites and is legally distinct because it enables both the development of an online community narrowly tailored to cater to the needs of the private securities industry and the creation of securities transactions pursuant to private offerings of securities that use general solicitation in a manner that is specifically designed to ensure compliance with federal securities law, particularly Rule 506(c).

The Present Invention is Novel, Useful and not Obvious to a Person Having Ordinary Skill in the Art to which the Present Invention Pertains

The present invention provides a mechanism that enhances the exposure of private offerings of securities while also reducing transaction costs, which is achieved, in part, by providing a means by which the identification of those potential investors who qualify as Accredited Investors could be more efficiently organized using the technological processes contemplated by the present invention, the documentation and settlement of securities transactions could be more efficiently organized and more creatively configured using the technological processes contemplated by the present invention, the dissemination of information between market participants could be enhanced by creating channels of communication directly connecting sellers and purchasers of securities using social networking technology, the experience of participants in the private securities industry could be more personalized by permitting such users to create profiles containing descriptive information that would become broadly accessible to other users, the quality of investment decision-making could be improved since greater access to information, improved channels of communication, and greater flexibility in manipulating and organizing data provides investors with more and better quality information to base an investment decision and transaction risk could be reduced by automating the processes by which funds and securities are transferred and delivered.

Historically, particularly prior to the enactment of Rule 506(c), the creation of private securities transactions arising from Rule 506 private offerings of securities were prohibited by law to have been arranged through the use of general solicitation. As a result, broker-dealers have played a significant role in the creation of private securities transactions, typically as placement agents of an Issuer. Private securities transactions created pursuant to Prior Rule 506, which is the exemption from registration typically relied upon in the creation of private securities transactions apart from Rule 506(c), could only be created if the parties had a “pre-existing relationship.” The functionality of broker-dealers in the creation of private securities transactions derives from the extensive rolodex of Accredited Investors with whom such broker-dealers have a pre-existing relationship. By engaging a broker-dealer to serve as its placement agent, an issuer is able to create private securities transactions by tapping into pools of capital provided by those certain Accredited Investors with whom such engaged broker-dealers have a pre-existing relationship. However, because Rule 506(c), under certain circumstances, eliminates the requirement that parties to the creation of private securities transactions have a pre-existing relationship, the need for the participation of broker-dealers in the creation of private securities transactions is no longer a functional pre-requisite.

The recent enactment of Rule 506(c) serves as the basis for the present invention and contemplates the use of general solicitation in the creation of private securities transactions in a manner not previously permitted by law or suggested or contemplated by others. Specifically, the present invention contemplates using the internet, and similar mass communications technology, as a means to disseminate general solicitations regarding private securities offerings and create securities transactions between those users who are introduced and are able to establish relationships directly between themselves, without an intermediary, through communications transmitted via the internet or similar mass communications technology. Accordingly, the method and system contemplated by the present invention is useful because it eliminates the need for broker-dealers by utilizing technological forums and other technical processes to serve as a functional surrogate in the role traditionally played by such broker-dealers in the creation of private securities transactions.

In addition to providing a process for using general solicitation in connection with private offerings of securities and providing an electronic means for automatically creating securities transactions as contemplated by such offerings, the present invention also contemplates the creation of a social network of technological forums specifically designed to meet the needs and preferences of participants in the private securities industry and encourage capital formation by broadening public access to information regarding participants in the private securities industry and allowing users of the present invention to broadcast biographical data, information regarding preferences, securities holdings and other information which would serve to enhance the quality and quantity of information in the private securities marketplace.

Given that broker-dealers have historically been the middlemen between potential investors and issuers seeking to raise capital through equity financing, the current private securities market is inefficient and increases transaction costs because the fees charged by such broker-dealers are costs that could be eliminated and/or reduced by the implementation of the present invention, which seeks to directly connect sellers of securities with potential purchasers of securities using technological processes to replace the role broker-dealers have played in organizing such transactions. Because of the Prior Rule 506 Prohibitions, specifically the requirement that a potential investor have a “pre-existing relationship” with the issuer or broker-dealer undertaking the Prior Rule 506 offering, issuers often rely on such broker-dealers to help effectuate Prior Rule 506 securities offerings because such broker-dealers have a sufficient number of “pre-existing relationships” with potential investors to enable issuers to reach their capital raising goals while also complying with Prior Rule 506, which would be far more difficult to achieve without access to the pools of pre-existing relationships accessible to broker-dealers. in the absence of engaging broker-dealers to help effectuate prior 506 offerings, issuers often experience significant difficulties in meeting their capital raising goals under Prior 506 offerings because of the shallower pool of potential investors with whom they are permitted to create private securities transactions in compliance with Prior Rule 506. In contrast with Prior Rule 506, reliance on Rule 506(c), which abolished of the Prior Rule 506 Prohibitions, enables issuers to directly contact a larger pool of potential investors without the need to engage broker-dealers since, under Rule 506(c), such issuers are permitted to use general solicitation to directly market their Rule 506(c) offerings to potential investors and are not constrained by the limitation that they have any “pre-existing relationships” with such potential investors. As a result, the method and system contemplated by the current invention is novel and improves the current private securities market by enabling Issuers to directly contact a larger pool of potential investor using general solicitations transmitted using the Internet or similar mass communications technology to directly market their Rule 506(c) offerings to potential investors without the need to engage Broker-Dealers.

The current private securities market is also inefficient because of the limitations on the manner in which potential investors can review information private offerings of securities. Typically, potential investors are not able to view information regarding private offerings of securities in a centralized format through which specific offerings can be meaningfully compared to other offerings using certain metrics, such as, but not limited to, the purchase price of the securities offered, market capitalization of the Issuer, industry of the Issuer, purchase price of securities offered as compared to the market price of the Issuer's securities, stock exchange in which the issuer's securities trade, volatility of the market price of the issuer's securities, dividend history of the Issuer's securities and other relevant factors. The method and system contemplated by the present invention is novel and improves the current private securities market by using technological processes, such as data tagging, data aggregation and tag manipulation, to allow potential investors to view offerings in accordance to a highly customizable set of criteria provided by such potential investors and to compare such offerings to other offerings on the basis of such criteria.

The current private securities market is also inefficient because of the limitations on the number of securities transactions that can be created in a single undertaking Typically, investors must fill out and authorize individual sets of transaction documents for each offering of securities offered by an Issuer. If an investor wants to purchase securities from multiple Issuers pursuant to the terms of multiple private offerings, multiple sets of transaction documents must be filled out and authorized for each securities purchase. The present invention seeks to simplify the process of purchasing securities from multiple issuers pursuant to multiple offerings by utilizing technological processes that would allow purchasing investors to select multiple offerings for investment, in accordance to criteria provided by a purchasing investor, and fill out and authorize multiple sets of transaction documents simultaneously, which would reduce the time and effort required for each purchasing investor to create multiple private securities transactions by reducing the number of inputs required from such purchasing investors. The method and system contemplated by the present invention is novel and improves the current private securities market by eliminating duplication in the preparation of transaction documents and reducing the time to settle such transactions by allowing for the creation of multiple securities transactions simultaneously.

Another shortcoming of the current private equities market disadvantages those certain qualifying investors who are not able to access the current private securities market because they lack exposure to information regarding private securities offerings and/or lack the capacity to consummate such transactions in a convenient and timely fashion. The creation of securities transactions pursuant to Prior Rule 506 offerings do not take utilize networks of technological forums and methods of processing through computer processing units in a manner that is publicly accessible or the most efficient. Qualifying potential investors who do not have exposure to private securities offerings, but would otherwise elect to invest in such offerings if exposed and given the opportunity to purchase securities through the internet, or similar mass communications technology, are not able to purchase securities directly from issuers or participate in the current private securities market. As a result, this class remains relatively underserved in the current market. Given the increasing prevalence of social networking in conjunction with the enactment of Rule 506(c), creating internet-based social networks that are narrowly tailored to facilitate the rapid consummation of securities transactions exempt under Rule 506(c) are expected to generate significant utility by promoting capital formation for a broader range of issuers, as a result of easier access to capital markets, encouraging investment from a deeper pool of investors, as a result of increased availability of information regarding private securities offerings and implementing automation in an industry that historically has not been able to exploit the advantages of technology. The method and system contemplated by the current invention is novel and improves the current private securities market by allowing for the dissemination of general solicitation regarding private securities offerings, in reliance upon Rule 506(c) (as defined below), through a social centralized network of technological forums specifically tailored to identify and aggregate issuers, private offerings of securities and Accredited Investors.

The current private securities market contains numerous other shortcomings related to the manner in which private securities transactions are settled, namely the manner in which funds are disbursed, fees extracted and the issuance of securities are authorized. Currently, the settlement of private securities transactions is not typically conducted through an automated process that settles such transactions electronically. Upon the execution of transaction documents authorized in accordance with Prior Rule 506, funds paid by purchasing investors are held in escrow until disbursement is authorized by the issuer, and in some cases the participating broker-dealer, and allocated pursuant specific instructions delivered to the agent in charge of escrow for the subject offering. Further, the authorization by the issuer of the issuance of securities purchased by such purchasing investors is typically conducted manually through communications by and between the issuer and the issuer's transfer agent. The amount of time to effectuate the disbursement of funds and the issuance of securities can be lengthy, depending on the diligence of the issuer and the issuer's transfer agent, and is not an instantaneous process. The method and system contemplated by the current invention is novel and improves the current private securities market by reducing the time necessary to settle private securities transactions by instituting a system of electronically transferring funds from the purchasing investor's account to the accounts of the issuers and automating the transmission of securities issuance authorization documents to the issuer's transfer agent directing such transfer agent to issue securities to such purchasing investor in accordance with the terms of the purchasing investor's purchase of the issuer's securities.

As a result, the present invention is novel, useful and materially differs from other processes for creating private securities transactions in a manner that is not obvious because it combines the ability to electronically create private securities transactions using general solicitation in manner not previously permitted by law prior to the enactment of Rule 506(c), the benefits of social networking mass communications technology that allow users of the present invention to broadcast biographical data, information regarding preferences, securities holdings and other information to the public as well as compare different offerings using a customizable set of metrics, which would specifically serve to enrich the quality and quantity of information in the private securities marketplace, and enhance flexibility in the creation of securities transactions by enabling groups of transactions arising from multiple offerings to be effectuated from a single set of inputs.

### SUMMARY OF THE INVENTION

### General Summary of the Present Invention

The preferred embodiment of the present invention contemplates the use of a social networking website that is specifically designed to combine the ability to electronically create private securities transactions using general solicitation in compliance with the Securities Act, utilize the benefits of social networking mass communications technology to allow users to broadcast biographical data, information regarding preferences, securities holdings and other information to the public as well as to compare different offerings using a customizable set of metrics, which would specifically serve to enrich the quality and quantity of information in the private securities marketplace, and enhance flexibility in the creation of securities transactions by enabling groups of transactions arising from multiple offerings to be effectuated from a single set of inputs. The process deployed by the present invention is designed to enable the creation and settlement of private securities transactions between users through the internet, or similar mass communications technology, in compliance with federal securities law by simplifying the process through which users can access capital markets using a user interface that is broadly accessible, easy to navigate and has low barriers to entry relative to existing private securities markets. Further, by the use of information circulation, data processing and electronic authorization techniques, the preferred embodiment of the present invention enables users to share information with other users over the internet or similar mass communications technology, customize the organization of information transmitted by other users and electronically authorize the purchase and sale of securities in a wide variety of configurations, ranging from single transactions to clusters of transactions authorized simultaneously. In addition, through the use of data aggregation, tagging and displays on a centralized publicly-accessible technological forum, the website contemplated by the present invention enables pools of investors and investments to be identified and be subjected to increased development and public access using electronically and not in a manner dependent on broker-dealers or other middlemen.

The present invention is designed to remove many of the traditional barriers to access to capital markets and promote the capitalization and growth of businesses. The present invention will open access to private securities offerings to a much wider range of potential investors than existing private securities markets as described in the Background section above by employing Rule 506(c), which is a securities regulation that permits offerings of securities to an unlimited number of Accredited Investors without the requirement that Issuers have a “pre-existing relationship” with such potential investors, allows Issuers to raise unlimited amounts of capital and permits Issuers and Broker-Dealers to use General Solicitation in marketing offerings of securities, and creating a new form of social network on the internet, or similar mass communications technology, specifically designed to enhance the dissemination of information regarding private securities offerings, enable the creation of private securities transactions on a scale not currently in effect and enrich the quality and quantity of publicly information regarding the private securities industry. The present invention will open access to the capital markets to a much broader base of issuers, investors and financial services professionals, lower transaction costs and shorten settlement periods. In short, the present invention offers numerous advantages not present in existing private securities markets by employing the internet, or similar mass communications technology, data processing techniques and other technological processes to create a new form of social network and enable capital formation in a novel and useful manner.

The preferred embodiment of the present invention decentralizes the manner in which such private securities transactions are conducted by relying on an online person-to-person transaction model that does not require broker-dealers to serve as the organizing hub through which such transactions must be filtered. By relying on an electronic person-to-person transaction model, it uses technological processes to shorten settlement periods, minimize transaction risk and increase the number of transactions that could be created using the same set of inputs. Further, the preferred embodiment of the present invention creates a more personalized investment experience by allowing users to create profiles about themselves, which enhances the amount and quality of information available in the public marketplace, and to contact other users, which fosters the development of relationships between users, increases the likelihood that private securities transactions would be created and promotes accountability. Lastly, the use of data aggregation and tagging allows users to make better investment decisions by allowing users to compare and manage data on the basis of a wide variety of metrics organized by tags and aggregated in a centralized forum. Therefore, a publicly accessible social networking website designed to meet the needs of the private securities industry, as contemplated as the preferred embodiment of the present invention, would provide investors, issuers and other participants in the private equities industry improved flexibility, creativity and choice in the creation of private securities transactions within a clear, well-defined and easily navigable technological structure.

### BRIEF DESCRIPTION OF THE DRAWINGS

The present invention will now be described by way of specific exemplary embodiments, to which it is not limited, by reference to the following drawings in which:

FIG. 1 is a flow diagram which illustrates the general process by a series of technological forums is used to form a social network narrowly tailored to be used for the electronic dissemination of data regarding the private securities industry in compliance with the Securities Act;

FIG. 2 is a flow diagram which illustrates the process by which Users who qualify as “Accredited Investors,” as defined in Regulation D of the Securities Act, are electronically identified;

FIG. 3 is a flow diagram which illustrates the process by which Users who qualify as “Accredited Investors,” as defined in Regulation D of the Securities Act may be electronically verified;

FIG. 4 is a flow diagram and a flow chart which illustrates the process by which general solicitations regarding Offerings are electronically created and disseminated;

FIG. 5 is a flow diagram which illustrates the process by which private securities transactions are created and settled electronically using the internet or similar mass communications technology, in compliance with the Securities Act, directly between Users using general solicitations in connection with an Offering to sell securities;

FIG. 6 is a flow diagram which illustrates the process by which private securities transactions are created and settled electronically using the internet or similar mass communications technology, in compliance with the Securities Act, directly between Users using general solicitations in connection with an Offering to purchase securities; and

FIG. 7 is a flow diagram which illustrates the process by which multiple sets of private securities transactions are created and settled electronically using the internet or similar mass communications technology, in compliance with the Securities Act, directly between Users using general solicitations in connection with Offerings to purchase or sell securities.

### DETAILED DESCRIPTION OF THE INVENTION

In general, securities markets are heavily regulated by various government authorities. These government authorities, through regulations and laws, impose burdens on Issuers, investors and Broker-Dealers. The extent of the burden is greater or lessor depending on the type of investment, the assumed sophistication of the investor and the perceived risks involved. They are usually geared to provide some protection for investors. Hence, the regulatory scheme imposed by government authorities generally defines trigger events and thresholds which, once crossed, impose additional duties of disclosure and other forms of protection that have the effect of increasing transactions costs.

The Securities Act has historically set forth various restrictions upon the manner in which securities could be bought and sold. Specifically, the prohibition on the use of general solicitation in connection with private securities offerings, as well as the corollary pre-existing relationship requirement, limited the application of technology in facilitating the creation of private securities transactions and growing the private securities industry, decreased the amount of information publicly accessible regarding private offerings of securities and imposed greater cost burdens in connection with the identification of investors who could participate in such offerings. In contrast, the enactment of Rule 506(c), which lifted the prohibition on the use of general solicitation in connection with private securities offerings if the issuer took reasonable steps to verify that the purchaser of the offered securities qualifies as an Accredited Investor, caused a paradigm shift in the regulatory scheme. As a result of the enactment of Rule 506(c) and as contemplated by the present invention, technological processes, including but not limited to mass communication, data processing and social networking technologies, are now permitted to be utilized in a manner which would decentralize control of private securities markets, implement greater automation in the creation of private securities transactions, deepen the pool of investors participating in such markets, improve the availability and quality of information and improve the economy as a whole by reducing transaction costs in connection with the manner in which businesses can gain access to capital.

The preferred embodiment of the present invention is a website operated by a Forum Provider through which data is uploaded, processed and stored on a server to form a social network narrowly tailored to serve the needs of the private securities industry. Through the website contemplated by the present invention, users can disseminate identification information, information regarding preferences, securities holdings and offers and effectuate and settle securities transactions through the internet or using similar mass communications technology. Particularly, the present invention contemplates a process which includes the steps of: (i) providing a method and system for creating a series of interconnected technological forums to form a social network on the internet, or using similar mass communications technology, narrowly tailored to be used for the electronic dissemination of data regarding the private securities industry in compliance with the Securities Act; (ii) providing a method and system for electronically identifying potential who qualify as Accredited Investors, as defined in Regulation D of the Securities Act; (iii) providing a method and system of electronically providing the means for verifying potential investors that qualify as “Accredited Investors, as defined in Regulation D of the Securities Act; (iv) providing a system and system for electronically creating general solicitations regarding Offerings; (v) providing a method and system of electronically creating and settling private securities transactions through the internet or using similar mass communications technology, in compliance with the Securities Act, directly between users of the present invention using general solicitations in connection with an offering to sell securities; (vi) of electronically creating and settling private securities transactions through the internet or using similar mass communications technology, in compliance with the Securities Act, directly between users of the present invention using general solicitations in connection with an Offering to purchase securities; and (vii) providing a method and system of creating and settling multiple sets of private securities transactions through the internet or using similar mass communications technology, in compliance with the Securities Act, directly between users of the present invention using general solicitations in connection with Offerings to purchase or sell securities. The present invention enables the revolutionary advancement of existing norms prevailing in the private securities industry by expanding and simplifying access to capital markets, deepening the pool of investors and investments using social networking, data processing and other technological processes and creating greater flexibility and choice in the creation of private securities transactions in a manner that has not yet been achieved.

### Regulatory Basis of the Present Invention

Securities offerings by issuers undertaken through the current private securities market typically rely primarily on Prior Rule 506 as the regulatory basis for selling securities to investors without registration with the SEC. Given the limitations in force because of the Prior Rule 506 Prohibitions, particularly the prohibition on the use of general solicitation in connection with private securities offerings and the pre-existing relationship requirement, broker-dealers have played a significant role in organizing, structuring and effectuating the creation of private securities transactions. The present invention contemplates a novel method of creating securities transaction in reliance on the newly enacted Rule 506(c), which lifted the Prior 506(c) Prohibitions in certain circumstances. The present invention follows a unique method and system which provides a useful, concrete and tangible result of providing a range of and access to investment opportunities not in existence before the present invention, disseminating information regarding securities offerings, issuers and potential investors through a social network and expediting the documentation, creation and settlement of securities transactions using mass communication technology and data processing techniques in a manner not previously suggested or contemplated by others.

Rule 506(c) offerings are unlimited in the amount of money that can be raised and in the number of investors that can participate for investment. Provided that Rule 506(c) offerings are registered in the states in which they are conducted (state securities registration is much less expensive and time-consuming than federal registration) and have filed all requisite forms in compliance with Rule 506, such as a “Form D,” such offerings can be undertaken by means of general solicitation via the internet and by other means of electronic communication. While general solicitation is permitted in connection with the marketing of 506(c) offerings, the creation of securities transactions under Rule 506(c) can only be accepted from those potential investors who qualify as Accredited Investors and provide to Issuers certain documents verify that such investors qualify as Accredited Investors. The present invention provides a method by which Accredited Investors can be identified using technological processes, which simplifies the creation of securities transactions by lowering transaction costs, and helps to ensure that such securities transactions are in compliance with Rule 506(c).

The present invention is designed to enable the creation of securities transactions in compliance with Regulation D of the Securities Act, specifically Rule 506(c), through a website on the internet, web application or similar mass communications technology, in order to increase the number of investors participating in the private securities industry, increase the total number of securities offerings which are publicly accessible, increase access to capital markets, increase diversification of investor portfolios by increasing exposure to investment opportunities and simplify and create greater flexibility and choice in the manner in which participants are able to structure and consummate private securities transactions.

### Method and System of Creating a Series of Interconnected Technological Forums to Form a Social Network Narrowly Tailored to be Used for the Electronic Dissemination of Data Regarding the Private Securities Industry

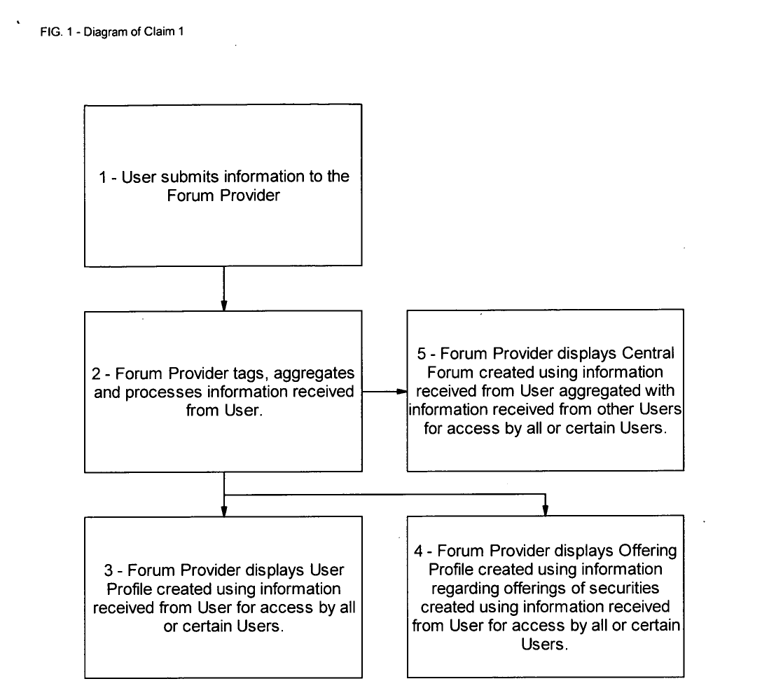

A method and system of creating a series of interconnected technological forums to form a social network on the internet, or similar mass communications technology, narrowly tailored to be used for the electronic dissemination of data regarding the private securities industry in compliance with the Securities Act, as contemplated by the present invention, is set forth in Claim 1 and depicted in FIG. 1, which illustrates the process by which data regarding offerings of securities and participants in the securities industry is electronically disseminated, indexed, tagged, linked, processed and displayed using the present invention for the purpose of creating a centralized listing of offerings of securities and of participants in the securities industry, improving the organization of such data, enhancing access to capital markets, promoting capital formation, creating relationships between participants in the securities industry and increasing the accessibility of information about participants in the private securities industry and of data regarding private securities offerings.

The first step in creating the method and system contemplated in Claim 1 is the submission of information uploaded through the internet, or using similar mass communications technology, to and stored on a server by a web site operator (hereinafter referred to as the “Forum Provider”) by users utilizing the present invention (each hereinafter referred to individually as a “User” or in multiples as “Users”) in accordance with instructions provided by the Forum Provider. Users upload information in accordance with form fields provided by the Forum Provider as part of a registration process. Information that may be uploaded by each User may include, but are not limited to, whether such Users are issuers, investors, broker-dealers or some other type of participant in the securities industry, industry of the User, whether User is listed on a stock exchange (if such User is an issuer of securities), pictures and other graphics, identifying and contact information, information regarding private offerings to purchase or sell securities, securities holdings, licenses, whether Accredited Investor Verification Documents are available for verification, information regarding user preferences. Such information provided by each user is to be stored on a server for display on the internet, or using similar mass communications technology, and processing by the Forum Provider. In addition to the uploading of information, users may be required to enter into legally binding agreements, authorized electronically, regarding terms of use, confidentiality, waiver and release, prohibition against the violation of applicable law, indemnification, and the acknowledgement of disClaimers as part of the registration process.

The second step in creating the method and system contemplated in Claim 1 is assigning a digital tag (each hereinafter referred to individually as a “Tag” or in multiples as “Tags”) to be stored on a server or similar data storage device to each datum of information provided by Users in Step 1, either based on the recognition of the content of each datum of information, the form field through which the information was submitted or other such similar conditions as may be determined by the Forum Provider. The processing of information provided by Users in Step 1 to create such Tags serves as the foundation for customizing the organization of such data since Users utilizing the present invention shall be able to view, compare, tag and sort information regarding securities offerings and other Users in accordance with preferences that correlate with the Tags created herein.

The third step in creating the method and system contemplated in Claim 1 creating unique user profiles (each hereinafter referred to individually as a “User Profile” or in multiples as “User Profiles”) which display data provided by Users in Step 1 of Claim 1 about the User attributable to the User Profile and contain channels of communication through which other Users can electronically contact the User attributed to the User Profile or input information to b e displayed on the User Profile. Each User shall be assigned a unique User Profile accessible over the internet, or using similar mass communications technology, constructed using information provided by Users in accordance with step 1. The User Profiles shall display information provided to the Forum Provider by the User, including but not limited to identifying and contact information, information regarding the background of the User, whether the User qualifies as an “Accredited Investor” and/or has made “Accredited Investor Verification Documents” available through the Forum Provider, the User's preferences, such as industries of interest, any securities offered for sale by the User and any securities offered for purchase by the User. The User Profiles shall also contain mechanisms by which other Users can electronically contact the User, either through private messaging or by posting on message boards located on each User Profile page.

The fourth step in creating the method and system contemplated in Claim 1 is the creation of unique offering profiles (each hereinafter referred to individually as an “Offering Profile” or in multiples as “Offering Profiles”) which display data provided by Users in Step 1 of Claim 1 about private offerings to purchase or sell securities (each hereinafter referred to individually as a “Offering” or in multiples as “Offerings”) and contain channels of communication through which other Users can electronically contact the User attributed to the Offering Profile or input information to be displayed on the Offering Profile. Each Offering shall be assigned a unique Offering Profile accessible over the internet, or using similar mass communications technology, constructed using information provided by Users in accordance with step 1. The Offering Profiles shall display information provided to the Forum Provider by the Offering User, including but not limited the number of securities offered for sale or purchase, the purchase price of the securities offered for sale or purchase, the rights and privileges of the securities offered for sale or purchase, special conditions of the Offering and the termination date of the Offering. The Offering Profiles shall also contain mechanisms by which other Users can electronically contact the Offering User, either through private messaging or by posting on message boards located on each Offering Profile page.

The fifth step in creating the method and system contemplated in Claim 1 is aggregating data provided by Users in Step 1 of Claim 1 on the basis of Tags created in Step 2 of Claim 1 to create a list of Users and/or Offerings in a publicly accessible central forum (hereinafter referred to as the “Central Forum”) that is organizable on the basis of Tags created in Step 2 of Claim 1 whereby data provided by Users in Step 1 of Claim 1 are displayed and bear a link to each corresponding User Profile or Offering Profile. Using the information provided by Users and the Tags generated therewith, User information is aggregated, indexed and displayed in the Central Forum. User information shall be organized and indexed by Tags and displayed on the Central Forum in accordance with the preferences of the User viewing the displayed data. For example, if a User elects to organize information to be displayed on the Central Forum on the basis of “Industry-type=technology; User-type=Issuer,” all Users who are tagged as Issuers specializing in “technology” will be displayed and all Users whose Tags do not meet this criteria will not be displayed. As another example, if a User elects to organize information to be displayed on the Central Forum on the basis of “User-type=Investor; Submitted Accredited Investor Verification Documents=Yes” all Users who are tagged as investors who have made Accredited Investor Verification Documents available for verification will be displayed and all Users whose Tags do not meet this criteria will not be displayed. As a third example, if a User elects to organize information to be displayed on the Central Forum on the basis of “Offering-type=Broker-Dealer,” all Offerings of securities underwritten by a broker-dealer will be displayed and all offerings not underwritten by a broker-dealer will not be displayed. In addition, Users shall have the option to view such data organized in an order customizable through the indication of additional preferences. For example, a User may elect to view such data in an order determined by the size of each issuer's market capitalization, pursuant to which User data shall be displayed in the Central Forum based on the size of each issuer's market capitalization in ascending order (or descending order if so elected). Depending on the preferences of each User and the Forum Provider, the information regarding each User that is displayed in the Central Forum may be restricted.

### Method and System of Electronically Identifying Users Who Qualify as Accredited Investors

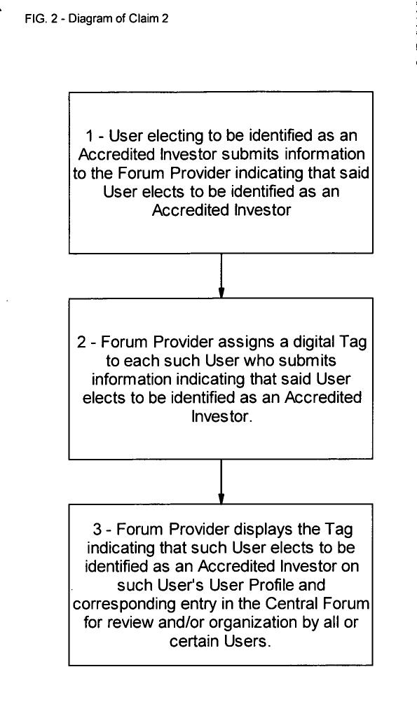

A method and system of electronically identifying Users who qualify as Accredited Investors, as contemplated by the present invention, is set forth in Claim 2 and depicted in FIG. 2, which illustrates the process by which Users are able to electronically identify themselves as Accredited Investors, are assigned Tags indicating that such Users have identified themselves as Accredited Investors and such Tags are displayed in such User's User Profile and corresponding entry in the Central Forum for the purpose of reducing transaction costs associated with identifying Accredited Investors by providing an electronic means by which such Accredited Investors can be identified and reducing the need for broker-dealers in identifying such Accredited Investors since the process contemplated by the present invention acts as a technological surrogate for the role historically played by such broker-dealers in identifying Accredited Investors.

The first step in creating the method and system contemplated in Claim 2 is the submission of information uploaded through the internet, or using similar mass communications technology, through form fields to the Forum Provider by Users who desire to be identified as Accredited Investors indicating that said User desires to be identified as an Accredited Investor. The self-identification of certain Users as Accredited Investors is valuable because, in the majority of circumstances, in order for a potential investor to purchase securities pursuant to exemptions from registration permitted under Regulation D, such potential investor is required to qualify as an Accredited Investor. By identifying themselves as Accredited Investors electronically, transaction costs borne by other parties associated with locating and identifying Accredited Investors is reduced because the present invention operates to create a central listing of such Accredited Investors easily accessible to such parties who desire to locate and identify such Accredited Investors.

The second step in creating the method and system contemplated in Claim 2 is assigning a digital Tag to be stored on a server or similar data storage device to each such User who submits information in accordance with Step 1 of Claim 2 indicating that said User desires to be identified as an Accredited Investor. The assignment of a Tag to certain Users indicating that such Users have identified themselves as Accredited Investors creates greater flexibility by which Users of the present invention can view, manipulate and organize data regarding the private securities industry. For example, if an issuer of securities intends to use general solicitation in connection with a private offering of securities that relies on the exemption from registration provided under Rule 506(c), such issuer can use the Tags created in Claim 2 to send general solicitations regarding such private offerings of securities to only those Users who have been assigned Tags indicating that such Users have identified themselves as Accredited Investors.

The third step in creating the method and system contemplated in Claim 2 is displaying the Tags indicating that such Users who submit information in accordance with Step 1 of Claim 2 have identified themselves as Accredited Investors on each such Users' User Profile and corresponding entries in the Central Forum. The display of such Tags is useful because allows other Users to quickly distinguish these Users from other Users who have not been assigned the Tag indicating that such User has identified itself as an Accredited Investor.

Method and System of Electronically Providing the Means for Verifying Users that Qualify as Accredited Investors

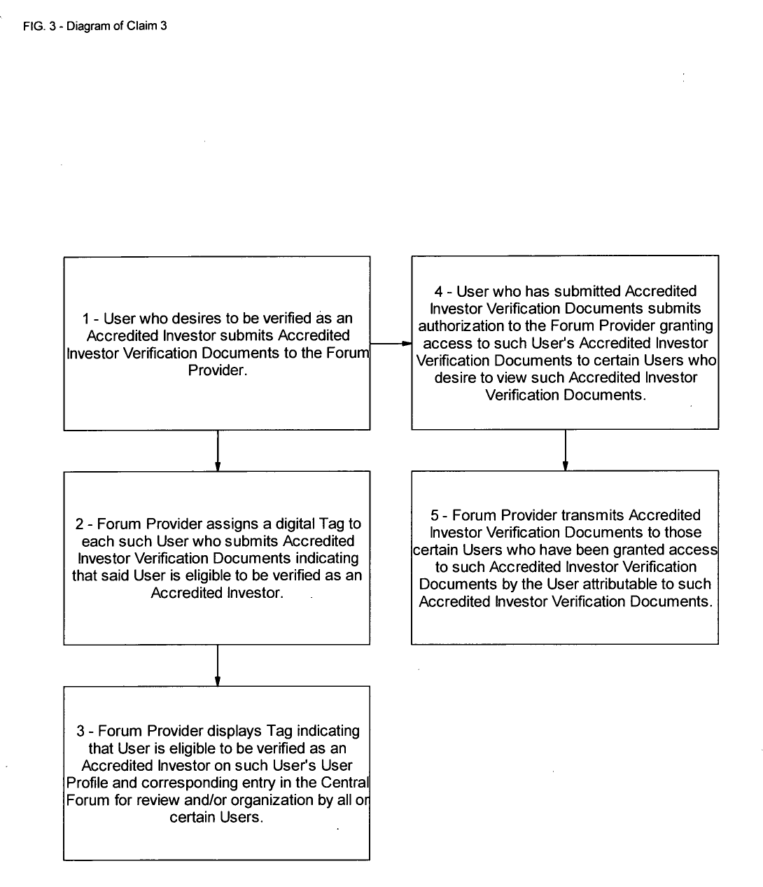

A method and system of electronically providing the means for verifying Users that qualify as Accredited Investors, as contemplated by the present invention, is set forth in Claim 3 and depicted in FIG. 3, which illustrates the process by which Users who desire to be verified as Accredited Investors may upload Accredited Investor Verification Documents to the Forum Provider for storage on a server for transmission to other Users who desire to review the Accredited Investor Verification Documents for the purpose of electronically verifying that such User qualifies as an Accredited Investor.

The first step in creating the method and system contemplated in Claim 3 is the submission of one or more of the following documents, as applicable (hereinafter individually and collectively referred to herein as the “Accredited Investor Verification Documents”), uploaded through the internet, or using similar mass communications technology, to the Forum Provider by Users who desire to be verified as Accredited Investors:
for verification of Accredited Investor status based on income, copies of any Internal Revenue Service form that reports income, such as Form W-2, Form 1099, Schedule K-1 of Form 1065, or a filed Form 1040;
for verification of Accredited Investor status based on net worth, specific types of documentation, dated within the prior three months, such as bank statements, brokerage statements, certificates of deposit, tax assessments and a credit report from at least one of the nationwide consumer reporting agencies, and obtaining a written representation from the investor;
for verification of Accredited Investor status based on attestation, a written confirmation from a registered broker-dealer, an SEC-registered investment adviser, a licensed attorney or a certified public accountant stating that such person or entity has taken reasonable steps to verify that the potential purchasing user is an Accredited Investor within the last three months and has determined that such purchaser is an Accredited Investor;
for verification of Accredited Investor status based on existing shareholder status, documentation verifying the accredited investor status of persons who had invested in an Issuer's Rule 506(b) offering as an Accredited Investor before Sep. 23, 2013 and remain investors of the issuer; and
any and all other documents upon which sellers or issuers of securities can rely, in compliance with the Securities Act and future amendments thereto, to verify that such Users who desire to be verified as Accredited Investors qualify as Accredited Investors.
   Rule 506(c), which sets forth the types of documentation that Issuers can rely upon to verify whether a potential purchasing user qualifies as an Accredited Investor, is the basis for the verification process set forth herein. Because of the costs associated with identifying and verifying that potential investors qualify as Accredited Investors, such costs are decreased using the present invention since such Accredited Investor Verification Documents can be transmitted quickly via electronic means to multiple parties at the direction of the User attributed to such Accredited Investor Verification Document.

The second step in creating the method and system contemplated in Claim 3 is assigning a Tag to be stored on a server or similar data storage device to each such User who submits documentation in accordance with Step 1 of Claim 3 indicating that said User is eligible to be verified as an Accredited Investor. The assignment of a Tag to certain Users indicating that such Users are eligible to be verified as Accredited Investors creates greater flexibility by which Users of the present invention can view, manipulate and organize data regarding the private securities industry. For example, if an issuer of securities intends to use general solicitation in connection with a private offering of securities that relies on the exemption from registration provided under Rule 506(c), such issuer can use the Tags created in Claim 3 to send general solicitations regarding such private offerings of securities to only those Users who have been assigned Tags indicating that such Users are eligible to be verified as Accredited Investors.

The third step in creating the method and system contemplated in Claim 3 is displaying Tags indicating that such Users who submit documentation in accordance with Step 1 of Claim 3 are eligible to be verified as Accredited Investors on such Users' User Profile and corresponding entries in the Central Forum. The display of such Tags is useful because allows other Users to quickly distinguish these Users from other Users who have not been assigned the Tag indicating that such User is eligible to be verified as an Accredited Investor.

The fourth step in creating the method and system contemplated in Claim 3 is the submission of authorization uploaded through the internet, or using similar mass communications technology, to the Forum Provider by Users who have submitted Accredited Investor Verification Documents in accordance with Step 1 of Claim 3 granting access to such User's Accredited Investor Verification Documents to other Users, either on the basis of express grants of access by such User attributable to such Accredited Investor Verification Documents to each other User or on another basis to be determined by such User attributable to such Accredited Investor Verification Documents. Because of the sensitive and confidential nature of information typically found in the Accredited Investor Verification Documents, the User attributed to those documents shall be given the option to transmit the Accredited Investor Verification Documents only to those select parties, or range of parties, as expressly authorized.

The fifth step in creating the method and system contemplated in Claim 3 is the transmission of Accredited Investor Verification Documents through the internet, or using similar mass communications technology, to Users who have been granted access to such Accredited Investor Verification Documents in accordance with Step 4 of Claim 3 by the User attributable to such Accredited Investor Verification Documents. Because verification that a purchaser of securities qualifies as an Accredited Investor is an express condition of Rule 506(c), sellers of securities who wish to rely on the exemption from registration set forth under Rule 506(c) can use the present invention to verify such purchasers of securities qualify as Accredited Investors. Therefore, after receipt and review of the Accredited Investor Verification Documents by a seller of securities, the seller of securities shall have sufficient information available to make a decision as to whether such seller is legally permitted by law to proceed with the sale. In the event that more information is required, the seller shall also have the opportunity to contact the potential purchaser using the communication channels provided by the present invention.

### Method and System of Electronically Creating General Solicitations Regarding Private Offerings

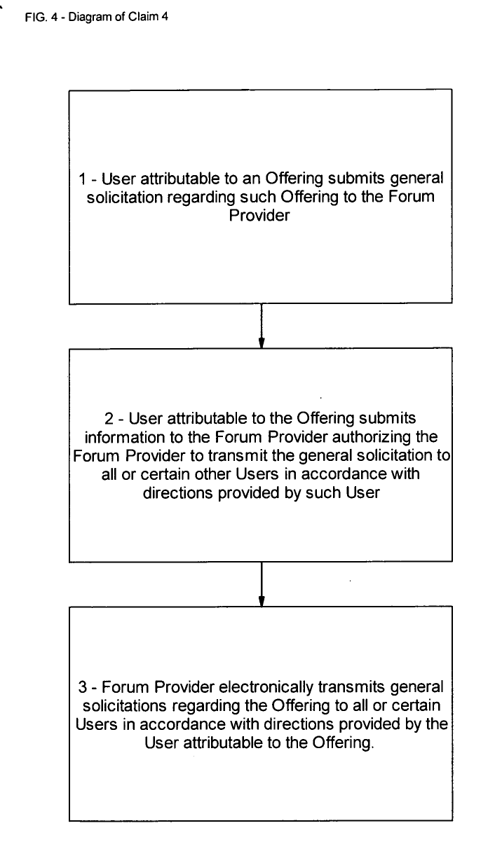

A method and system of electronically creating and disseminating general solicitations regarding Offerings, as contemplated by the present invention, is set forth in Claim 4 and depicted in FIG. 4, which, in reliance on Rule 506(c), illustrates the process by which information regarding Offerings of securities, such as the number of securities offered, the purchase price of the securities offered, the rights and privileges of the securities offered, conditions of the offering and the termination date of the Offering shall be used to generate general solicitations for distribution to those Users specified by the User attributable to the Offering (hereinafter individually referred to as an “Offering User” or in multiples as “Offering Users”). Based on the preferences of the Offering User, such as limitations on allowing access to only those certain users who have uploaded Accredited Investor Transaction Documents, documentation in connection with the private offering may be made available to other users for their review using private channels accessible from the Offering User's User Profile, from the Central Forum or from the Offering Profile. The Offering User shall be given the option to transmit the general solicitation regarding the Offering to other Users based on the preferences of the Offering User and the preferences of the Users who are specified to receive the general solicitation.

The first step in creating the method and system contemplated in Claim 4 is the submission of information to the Forum Provider by Offering Users containing information regarding such Offerings to be electronically disseminated to other Users (hereinafter referred to individually as a “General Solicitation” or in multiples as “General Solicitations”). Using the method of creating General Solicitations contemplated by the present invention, sellers of securities can quickly create General Solicitations specifically designed to include all necessary information regarding the Offerings underlying such General Solicitations as well as other information in connection with marketing and promotion of such Offerings.

The second step in creating the method and system contemplated in Claim 4 is the submission of electronic authorization by Offering User to the Forum Provider granting access to other Users who are authorized to receive the General Solicitations created in Step 1 of Claim 4, as determined either on the basis of Tags or on another basis to be determined by such Offering User. The electronic authorization defining the scope of Users that the Offering User intends to send such General Solicitations allows the Offering User to target specific Users and to narrowly tailor such General Solicitations to market the Offering to such specific Users.

The third step in creating the method and system contemplated in Claim 4 is the electronic transmission of General Solicitations through the internet, or using similar mass communications technology, to Users who have been granted access to such General Solicitations by the Offering User pursuant to Step 2 of Claim 4. Using the method of distributing the General Solicitations contemplated by the present invention, sellers of securities can quickly distribute General Solicitations by electronic means, thereby reducing the costs of distributing and creating such General Solicitations and enhancing access to information regarding the Offering to specific group of targeted Users.

Method and System of Electronically Creating and Settling Private Securities Transactions Through the Internet, or Similar Mass Communications Technology, in Compliance with the Securities Act, Directly Between Users Using General Solicitations in Connection with an Offering to Sell Securities

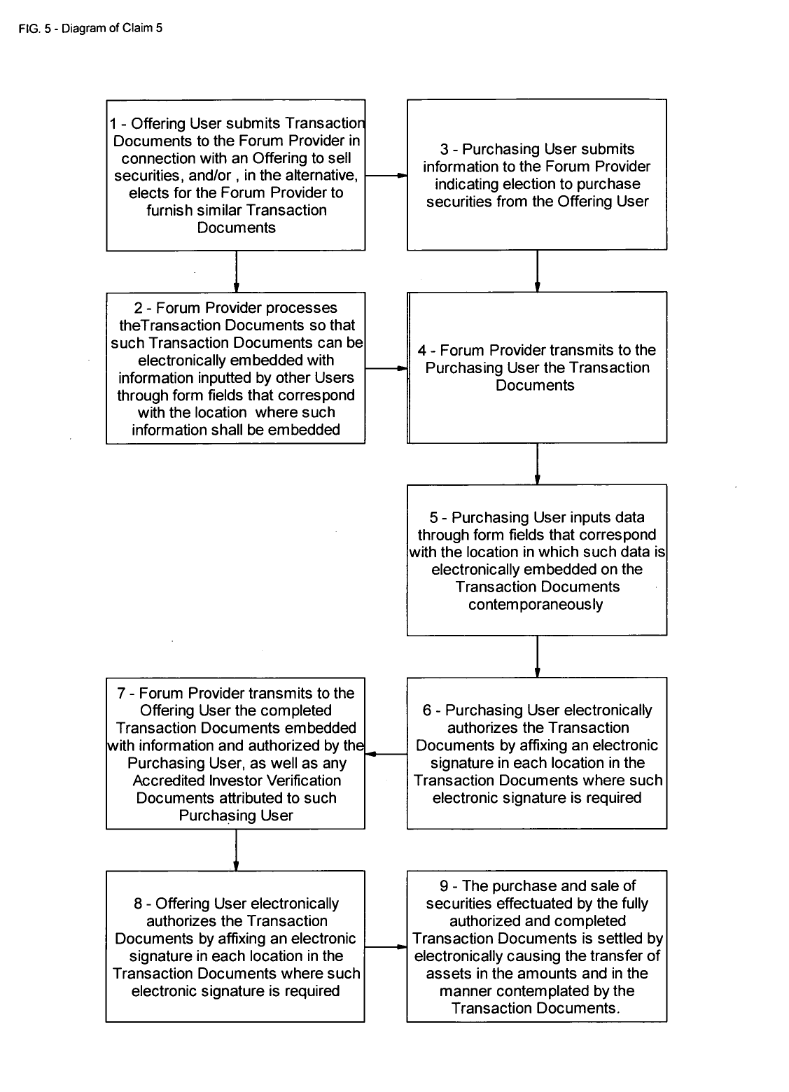

A method and system of electronically creating and settling private securities transactions through the internet, or using similar mass communications technology, in compliance with the Securities Act, directly between Users using general solicitations in connection with an Offering to sell securities, as contemplated by the present invention, is set forth in Claim 5 and depicted in FIG. 5, which illustrates the process by which documents necessary to effectuate transactions in securities are electronically embedded with information and authorized by electronic signature and the settlement of such securities transactions are electronically effectuated for the purpose of automating the process by which legally binding documents to effectuate sales of securities are created and authorized and reducing the amount of time in which such transactions could be settled.

The first step in creating the method and system contemplated in Claim 2 is the submission by Users offering to sell securities pursuant to an Offering or otherwise (hereinafter referred to in this Claim individually as an “Offering User” or in multiples as “Offering Users”) of all documents and information required to effectuate the sale and settlement of the securities offered for sale pursuant to such Offering (such documents, in addition to any similar documents provided by the Forum Provider or other third parties, collectively hereinafter referred to in this Claim as the “Transaction Documents”) to the Forum Provider. Information regarding private offerings of securities to be uploaded via form fields may include, but is not limited to the type of securities offered for sale, number of securities offered for sale, price of securities offered for sale, minimum/maximum number of securities to be purchased pursuant to each sale, rights and privileges of securities offered for sale, restrictions on securities offered for sale, date and time of termination of offering, corporate information of the issuer of the securities offered for sale, including issuer's contact information, issuer's state of incorporation, identity of and contact information for issuer's management, identity of and contact information for issuer's transfer agent, identity of and contact information for issuer's legal counsel or identity of and contact information for issuer's placement agent or underwriter, wiring instructions or other information necessary for the transfer of funds to be received by the offering user in exchange for sale of securities purchased pursuant to the offering.

If the Offering User is an issuer or a broker-dealer, the documents which may also be uploaded to the Forum Provider for dissemination through the social network contemplated by the present invention (as limited by restrictions on dissemination, if any, indicated by the offeror) include but are not limited to “Prospectus,” “Private Placement Memorandum” or similar offering document setting forth the terms of the Offering, descriptions of securities offered and information regarding the Issuer of the securities to be purchased pursuant to the offering, “Subscription Agreement” setting forth the terms of the purchase and sale of the subject securities (along with the “Warrant,” “Option,” “Debenture” or any other documents evidencing the securities to be purchased pursuant to the Offering), “Form D” to be filed with the SEC, “Blue Sky Filings” to be filed with state regulatory agencies (as applicable), “Bad Actor Disclosure” setting forth required items and certifications regarding the issuer, and other required parties, in accordance with requirements under Regulation D of the Securities Act, “Registration Rights Agreement” if the purchasing investor shall be entitled to registration rights in connection with the securities purchased pursuant to the offering, “Confidentiality and Non-Disclosure Agreement” if, as a condition of viewing information regarding the Offering, the offeror desires to legally obligate offerees to keep information regarding the offering and/or the issuer confidential and to prohibit the dissemination of such information to third-parties, financial statements of the issuer of securities setting forth certain financial information regarding the issuer in either audited or unaudited form, regulatory filings, if any, setting forth information required to be disclosed by the issuer under federal law, “Certificate of Good Standing” setting forth a certification by the Secretary of State of the state of incorporation of the issuer that the issuer is validly in existence and in good standing with the state of incorporation.

If the Offering User is an existing securities holder offering to sell securities held, the documents which may also be uploaded in addition to the foregoing for dissemination through the social network contemplated by the present invention (as limited by restrictions on dissemination, if any, indicated by the offeror) include but are not limited proof of current beneficial ownership of the securities to be sold pursuant to the offering, which may include executed “Signature Medallion Guarantee,” offeror's brokerage account information, copies of physical stock certificates, warrants, debentures or any other documents verifiably attesting to the ownership and/or control of the securities offered to be sold pursuant to the offering and Stock Purchase Agreement setting forth the terms of the purchase and sale of the subject securities.

The second step in creating the method and system contemplated in Claim 5 is processing the Transaction Documents provided in accordance with Step 1 of Claim 5 so that such Transaction Documents could be electronically embedded with information inputted through form fields that correspond with the location in the Transaction Documents where such information shall be embedded. Such information that shall be eligible to be embedded on such transaction documents include but are not limited to electronic signatures or other similar form of legally binding electronic authorization, identifying and contact information, number of securities to be purchased, purchase price of the subject securities to be purchased and information regarding payment. By processing the Transaction Documents so that they could be electronically embedded with information, multiple sets of Transaction Documents could be electronically embedded with information quickly and automatically.

The third step in creating the method and system contemplated in Claim 5 is the submission of information by Users who elect to accept the offer to purchase securities offered for sale by the Offering User (each such User hereinafter referred to in this Claim as the “Purchasing User” or in multiples as “Purchasing Users”) indicating acceptance of the offer to purchase the securities offered for sale by the Offering User through channels accessible through the Central Forum, the Offering User's User Profile or the Offering User's Offering Profile. After reviewing an Offering User's General Solicitation in connection with a private offering to sell securities, potential Purchasing Users shall indicate interest in purchasing the securities offered for sale by the offering user through channels provided on the Central Forum, the Offering User's User Profile or the Offering Profile. Based on the preferences of the Offering User, such as limitations on allowing access to only those certain potential Purchasing Users who have uploaded Accredited Investor Transaction Documents, such potential Purchasing Users who have indicated interest in purchasing the offered securities shall receive access to those certain Transaction Documents processed under step 2 or, if such documents have not been provided by the Offering User, by such similar documents provided by the Forum Provider that have been processed in a manner similar to as contemplated under step 2.

The fourth step in creating the method and system contemplated in Claim 5 is the transmission to the Purchasing User, for review, the Transaction Documents submitted pursuant to Step 1 of Claim 5. Prior to acceptance of conditions of the Offering and the purchase of the subject securities, the Purchasing User will be sent the Transaction Documents for review and shall decide to proceed with the transaction on the basis of review of such documents.

The fifth step in creating the method and system contemplated in Claim 5 is the creation of legally binding Transaction Documents obligating Purchasing Users to purchase securities from the Offering User in accordance with the terms of the Offering by inputting data necessary to complete such transaction documents through form fields provided by the Forum Provider that correspond with the location in which such information shall be embedded on the Transaction Documents. The Purchasing User shall input data necessary to complete such Transaction Documents through form fields provided by the Forum Provider that correspond with the location in which such information shall be embedded on each document. Using Transaction Documents provided to the Forum Provider by the Offering User that were processed in accordance with step 2, or in the alternative and depending on the preferences of the Forum Provider and the offering user, transaction documents provided by the Forum Provider that are in substantially the same form as those which would have been provided to the Forum Provider by the Offering User, such data inputted by the Purchasing User shall be electronically embedded in the Transaction Documents in the location that corresponds with the form field through which such data was submitted. Such data inputted shall include, but are not limited to, identification and contact information, number of securities to be purchased, total purchase price of the subject securities to be purchased, tax payer identification number, payment information and attestation that the Purchasing User qualifies as an Accredited Investor. In the alternative, such Transaction Documents may also be embedded with automatically generated information as provided by the Purchasing User pursuant to Claim 1. The Purchasing User will then be given the option to review the Transaction Documents, make corrections and verify that the information embedded is accurate.

The sixth step in creating the method and system contemplated in Claim 5 is the electronic authorization by the Purchasing User of the legally binding Transaction Documents created pursuant to Step 5 of Claim 5 by affixing the electronic signature of such Purchasing User in each location in the Transaction Documents where such electronic signature of the Purchasing User is required. After the Transaction Documents have been embedded with information pursuant to Step 5, the Purchasing User shall embed the Transaction Documents with an electronic signature authorizing the purchase of securities from the Offering User in accordance with the terms and conditions set forth in the Transaction Documents. In the event that the Purchasing User has not uploaded Accredited Investor Verification Documents and such documents are necessary to consummate the purchase of securities by the Purchasing User, the Purchasing User shall upload the Accredited Investor Verification Documents to the Forum Provider for distribution to the Offering User in accordance with Claim 2.

The seventh step in creating the method and system contemplated in Claim 5 is the transmission to the Offering User for review the Transaction Documents created pursuant to Step 5 of Claim 5 and authorized by the Purchasing User in Step 6 of Claim 5 and the Accredited Investor Verification Documents attributed to such Purchasing User submitted pursuant to Claim 2. Based on review the completed and authorized Transaction Documents, as well as any Accredited Investor Verification Documents (if necessary), the Offering User can elect to proceed with the transaction underlying such Transaction Documents, inquire for more information using channels of communication provided by the present invention or void the transaction.

The eighth step in creating the method and system contemplated in Claim 5 is the electronic authorization by the Offering User of the legally binding Transaction Documents received pursuant to Step 7 of Claim 5 by affixing the electronic signature of such Offering User in each location in the Transaction Documents where such electronic signature of the Offering User is required. After the Offering User affixes its electronic signature to the Transaction Documents already authorized by the Purchasing User, the securities transaction has been completed, subject to the settlement of the assets that are the subject of the Transaction Documents.

The ninth step in creating the method and system contemplated in Claim 5 is the electronic settlement of the sale of securities effectuated by the Transaction Documents by electronically sending an order on behalf of the Purchasing User to the Purchasing User's financial agent ordering such financial agent to transfer funds from Purchasing User's account in the amount set forth in the Transaction Documents to Offering User's account and/or to the accounts of Offering User's agents and assigns as directed in the Transaction Documents, electronically sending an order on behalf of the Offering User to the agent controlling the securities sold pursuant to the Offering to transfer such securities in the amount set forth in the Transaction Documents to the location for the receipt of delivery of the securities as directed in the Transaction Documents and sending electronic communications to the Offering User and the Purchasing User confirming the completion of the sale of securities contemplated by the Transaction Documents. Purchasing User shall have provided information regarding the means by which funds shall be transferred from the Purchasing User in satisfaction of Purchasing User's obligations in connection with the purchase of securities contemplated by the Transaction Documents, which may include but are not limited to credit card and debit card information, bank account information or wiring instructions, along with electronic authorization to transfer such funds, the location for the receipt of delivery of the securities, which may include the address of record of the Purchasing User, the Purchasing User's brokerage account or other location for which such securities shall be delivered and/or deposited and authorization for the electronic transfer of funds to the Offering User as set forth in the Transaction Documents. Offering User shall have provided information regarding the location where funds transferred from Purchasing User in connection with the purchase of the securities contemplated by the Transaction Documents shall be deposited, which may include bank account information or wire instructions, the location of the securities to be delivered to Purchasing User, such as Offering User's transfer agent, registrar, broker, legal counsel or other agent and electronic authorization directing such agent to issue and/or transfer the securities to the Purchasing User in accordance with the terms and conditions of the Transaction Documents.

Method and System of Electronically Creating Private Securities Transactions Through the Internet, or Using Similar Mass Communications Technology, in Compliance with the Securities Act, Directly Between Users Using General Solicitations in Connection with an Offering to Purchase Securities

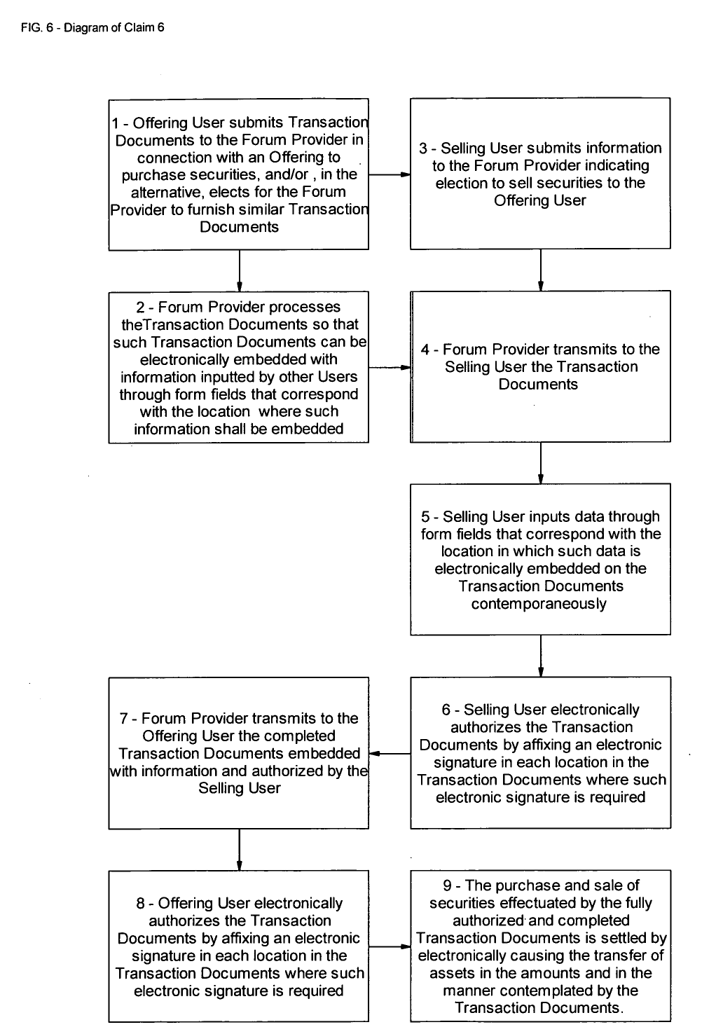

A method and system of electronically creating private securities transactions through the internet, or using similar mass communications technology, in compliance with the Securities Act, directly between Users using general solicitations in connection with an Offering to purchase securities, is set forth in Claim 6 and depicted in FIG. 6, which illustrates the process by which documents necessary to effectuate transactions in securities are electronically embedded with information and authorized by electronic signature and the settlement of such securities transactions are electronically effectuated for the purpose of automating the process by which legally binding documents to effectuate purchases of securities are created and authorized and reducing the amount of time in which such transactions could be settled.

The first step in creating the method and system contemplated in Claim 6 is the submission by Users offering to purchase securities pursuant to an Offering or otherwise (hereinafter referred to in this Claim individually as an “Offering User” or in multiples as “Offering Users”) of all documents and information, including Accredited Investor Verification Documents in accordance with Claim 2 if applicable, required to effectuate the purchase and settlement of the securities offered for purchase pursuant to such Offering (such documents, in addition to any similar documents provided by the Forum Provider or other third parties, collectively hereinafter referred to in this Claim as the “Transaction Documents”) to the Forum Provider. Offering users, typically broker-dealers, investors and other users who desire to purchase of securities and are qualified to do so, upload information to a Forum Provider, to be stored on a server, regarding private offerings to purchase securities in accordance with form fields provided by the Forum Provider. Information to be uploaded via form fields regarding private offerings to purchase securities may include, but is not limited to identification information regarding issuer of securities offered to be purchased, type of securities offered to be purchased, total number of securities offered to be purchased, purchase price for securities offered to be purchased, minimum number of securities to be purchased for each transaction and date and time of termination of offering to purchase securities. The documents which may also be uploaded for dissemination through the social network contemplated by the present invention (as limited by restrictions on dissemination, if any, indicated by the offeror) may include, but are not limited to, “Stock Purchase Agreement” setting forth the terms of the purchase and sale of the subject securities and, in the event that the Offering User has not uploaded Accredited Investor Verification Documents and such documents are necessary to consummate the purchase of securities by the Offering User from the Selling User, the Offering User shall upload the Accredited Investor Verification Documents to be transmitted as part of the Transaction Documents.

The second step in creating the method and system contemplated in Claim 6 is processing the Transaction Documents provided in accordance with Step 1 of Claim 6 so that such Transaction Documents could be electronically embedded with information inputted through form fields that correspond with the location in the Transaction Documents where such information shall be embedded. Such information that shall be eligible to be embedded on such transaction documents include but are not limited to electronic signatures or other similar form of legally binding electronic authorization, identifying and contact information, number of securities to be purchased, purchase price of the subject securities to be purchased and information regarding payment. By processing the Transaction Documents so that they could be electronically embedded with information, multiple sets of Transaction Documents could be electronically embedded with information quickly and automatically.

The third step in creating the method and system contemplated in Claim 6 is the submission of information by Users who elect to accept the offer to sell securities offered for purchase by the Offering User (each such User hereinafter referred to in this Claim as the “Selling User” or in multiples as “Selling Users”) indicating acceptance of the offer to sell the securities offered for purchase by the Offering User through channels accessible through the Central Forum, the Offering User's User Profile or the Offering User's Offering Profile. After reviewing an Offering User's General Solicitation in connection with a private offering to purchase securities, potential Selling Users shall indicate interest in selling the securities offered for purchase by the Offering User through channels provided on the Central Forum, the Offering User's User Profile or the Offering Profile. Based on the preferences of the Offering User, such as limitations on allowing access to only those certain potential Selling Users who are issuers of securities, such potential Selling Users who have indicated interest in selling the offered securities shall receive access to those certain Transaction Documents processed under step 2 or, if such documents have not been provided by the Offering User, by such similar documents provided by the Forum Provider that have been processed in a manner similar to as contemplated under step 2.

The fourth step in creating the method and system contemplated in Claim 6 is the transmission to the Selling User, for review, the Transaction Documents submitted pursuant to Step 1 of Claim 6. Prior to acceptance of conditions of the Offering and the sale of the subject securities, the Selling User will be sent the Transaction Documents for review and shall decide to proceed with the transaction on the basis of review of such documents.

The fifth step in creating the method and system contemplated in Claim 6 is the creation of legally binding Transaction Documents obligating Selling Users to sell securities to the Offering User in accordance with the terms of the Offering by inputting data necessary to complete such Transaction Documents through form fields provided by the Forum Provider that correspond with the location in which such information shall be embedded on the Transaction Documents. The Selling User shall input data necessary to complete such Transaction Documents through form fields provided by the Forum Provider that correspond with the location in which such information shall be embedded on each document. Using Transaction Documents provided to the Forum Provider by the Offering User that were processed in accordance with Step 2, or in the alternative and depending on the preferences of the Forum Provider and the Offering User, transaction documents provided by the Forum Provider that are in substantially the same form as those which would have been provided to the Forum Provider by the Offering User, such data inputted by the Selling User shall be electronically embedded in the Transaction Documents in the location that corresponds with the form field through which such data was submitted. Such data inputted shall include, but are not limited to, identification and contact information, number of securities to be sold, total purchase price of the subject securities to be sold, tax payer identification number, information regarding where and how the securities are held by such Selling User and attestation that the Selling User is permitted to sell the subject securities pursuant to the terms of the Offering. In the alternative, such Transaction Documents may also be embedded with automatically generated information as provided by the Selling User pursuant to Claim 1. The Selling User will then be given the option to review the Transaction Documents, make corrections and verify that the information embedded is accurate.

The sixth step in creating the method and system contemplated in Claim 6 is the electronic authorization by the Selling User of the legally binding Transaction Documents created pursuant to Step 5 of Claim 6 by affixing the electronic signature of such Selling User in each location in the Transaction Documents where such electronic signature of the Selling User is required. After the Transaction Documents have been embedded with information pursuant to Step 5, the Selling User shall embed the Transaction Documents with an electronic signature authorizing the sale of securities to the Offering User in accordance with the terms and conditions set forth in the Transaction Documents. In the event that the Offering User has not uploaded Accredited Investor Verification Documents and such documents are necessary to consummate the sale of the subject securities by the Selling User, the Offering User shall upload the Accredited Investor Verification Documents to the Forum Provider for distribution to the Selling User in accordance with Claim 2.

The seventh step in creating the method and system contemplated in Claim 6 is the transmission to the Offering User for review the Transaction Documents created pursuant to Step 5 of Claim 6 and authorized by the Selling User in Step 6 of Claim 6. Based on review the completed and authorized Transaction Documents, the Offering User can elect to proceed with the transaction underlying such Transaction Documents, inquire for more information using channels of communication provided by the present invention or void the transaction.

The eighth step in creating the method and system contemplated in Claim 6 is the electronic authorization by the Offering User of the legally binding Transaction Documents received pursuant to Step 7 of Claim 6 by affixing the electronic signature of such Offering User in each location in the Transaction Documents where such electronic signature of the Offering User is required. After the Offering User affixes its electronic signature to the Transaction Documents already authorized by the Selling User, the securities transaction has been completed, subject to the settlement of the assets that are the subject of the Transaction Documents.

The ninth step in creating the method and system contemplated in Claim 6 the electronic settlement of the sale of securities effectuated by the Transaction Documents by electronically sending an order on behalf of the Offering User to the Offering User's financial agent ordering such financial agent to transfer funds from Offering User's account in the amount set forth in the Transaction Documents to Selling User's account and/or to the accounts of Selling User's agents and assigns as directed in the Transaction Documents, electronically sending an order on behalf of the Selling User to the Selling User's agent controlling the securities sold pursuant to the Offering to transfer such securities in the amount set forth in the Transaction Documents to the location for the receipt of delivery of the securities as directed in the Transaction Documents and sending electronic communications to the Offering User and the Selling User confirming the transfer of assets and the completion of the sale of securities contemplated by the Transaction Documents. Offering User shall have provided information regarding the means by which funds shall be transferred from the Offering User in satisfaction of Offering User's obligations in connection with the purchase of securities contemplated by the Transaction Documents, which may include but are not limited to credit card and debit card information, bank account information or wiring instructions, along with electronic authorization to transfer such funds, the location for the receipt of delivery of the securities, which may include the address of record of the Offering User, the Offering User's brokerage account or other location for which such securities shall be delivered and/or deposited and authorization for the electronic transfer of funds to the Selling User as set forth in the Transaction Documents. Selling User shall have provided information regarding the location where funds transferred from Offering User in connection with the purchase of the securities contemplated by the Transaction Documents shall be deposited, which may include bank account information or wire instructions, the location of the securities to be delivered to Offering User, such as Selling User's transfer agent, registrar, broker, legal counsel or other agent and electronic authorization directing such agent to issue and/or transfer the securities to the Offering User in accordance with the terms and conditions of the Transaction Documents.

Method and System of Electronically Creating and Settling Multiple Sets of Private Securities Transactions Through the Internet, or Using Similar Mass Communications Technology, in Compliance with the Securities Act, Directly Between Users Using General Solicitations in Connection with Offerings to Purchase or Sell Securities

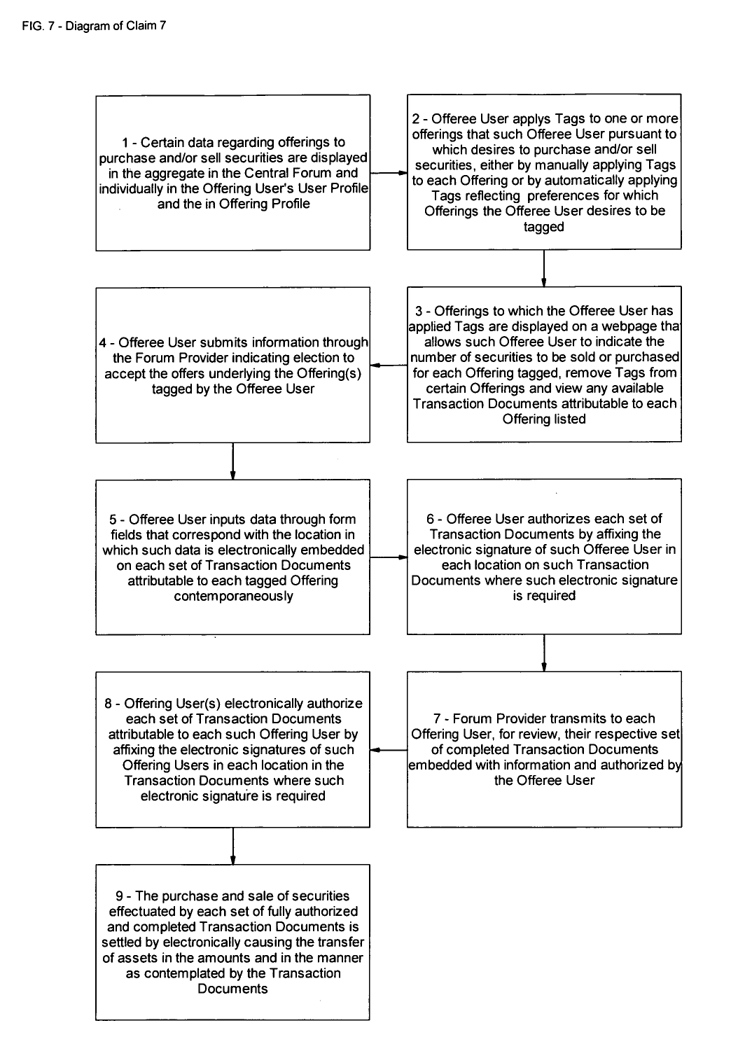

A method and system of electronically creating and settling multiple sets of private securities transactions through the internet, or using similar mass communications technology, in compliance with the Securities Act, directly between Users using general solicitations in connection with Offerings to purchase or sell securities, as contemplated by the present invention, is set forth in Claim 7 and depicted in FIG. 7, which illustrates the process by which by which general solicitations regarding offerings to purchase and/or sell securities are publicly disseminated through a social network located on the Internet, documents necessary to effectuate multiple transactions in securities are electronically embedded with information and authorized by electronic signature contemporaneously and the settlement of multiple securities transactions are electronically effectuated for the purpose of decreasing the number of inputs required to effectuate multiple transactions in securities, automating the process by which legally binding documents to effectuate multiple transactions in securities are created and authorized, reducing the amount of time in which multiple securities transactions could be settled and creating greater flexibility in the creation of portfolios of securities.

The first step in creating the method and system contemplated in Claim 7 displaying of data regarding Offerings to purchase or sell securities, either viewed as a list of Offerings that are aggregated and organized in the Central Form or viewed individually through an Offering Profile or through the User Profile of the User attributable to the Offering (each such User hereinafter referred to in this Claim individually as an “Offering User” or in multiples as “Offering Users”), on the website contemplated by the present invention. In the event the Offerings are viewed by the Users as part of a list of offerings in the Central Forum, then such Offerings may be organized, aggregated and displayed in accordance with Tags assigned to such Offerings.

The second step in creating the method and system contemplated in Claim 7 is applying Tags to one or more Offerings by a User that desires to purchase and/or sell securities in accordance with the terms of such Offerings (each such User hereinafter referred to in this Claim individually as an “Offeree User” or in multiples as “Offeree Users”), either by manually applying Tags to each Offering or by automatically applying Tags using inputs provided by the Offeree User to the Forum Provider indicating the preferences for which Offerings the Offeree User desires to be tagged. Single or multiple Offerings may be manually tagged by such user or automatically tagged by the Forum Provider using inputs provided by the potential participating user to the Forum Provider indicating the preferences for which Offerings the Offeree User desires to be tagged.

The third step in creating the method and system contemplated in Claim 7 is displaying the Offerings to which the Offeree User has applied Tags on a webpage that allows such Offeree User, at minimum, to indicate the number of securities to be sold or purchased for each Offering tagged in accordance with Step 2 of Claim 7, remove Offerings from the list of Offerings desired to be accepted by such Offeree User, view the potential allocation of assets after consummation of the transactions contemplated by the Offerings and receive any information or documentation made publicly available by each Offering User, including but not limited to those Transaction Documents submitted to the Forum Provider pursuant to Step 1 of Claim 5 and Step 1 of Claim 6 by each Offering User (such documents, in addition to any similar documents provided by the Forum Provider or other third parties, collectively hereinafter referred to in this Claim as the “Transaction Documents”), in connection with the Offerings that the Offeree User has applied a Tag. Through the website contemplated as the preferred embodiment of the present invention, the Offeree User shall be given the option to view the list of offerings that such Offeree User has tagged. The Offerings tagged by the Offeree User shall be listed on a webpage and the potential participating user shall be given the option to indicate the number of securities to be sold or purchased for each offering desired to be accepted, remove offerings from the list of offerings desired to be accepted, view any information or documentation made publicly available by the offering user in connection with the offerings tagged by potential participating user and receive any information or documentation made publicly available in connection with each Offering, including but not limited to each set of Transaction Documents attributed to each Offering, respectively.

The fourth step in creating the method and system contemplated in Claim 7 is the submission of information by the Offeree User indicating acceptance of the offers underlying the Offerings tagged by the Offeree User. After reviewing and modifying the list of Offerings tagged by Offeree User in accordance with step 3, the Offeree User shall be given the option to indicate acceptance of the offers underlying the tagged Offerings. Qualifying Offeree Users who elect to accept the offers underlying the tagged Offerings shall receive access to Prospectuses, agreements and all other Transaction Documents made available in connection with the creation securities transactions contemplated by the Offering and, if the Offeree User is a purchasing investor relying on Rule 506(c) or similar law or regulation, such Offeree User shall be given the option to upload Accredited Investor Verification Documents to the Forum Provider for dissemination to the Offering Users in accordance with Claim 2.

The fifth step in creating the method and system contemplated in Claim 7 is the creation of legally binding Transaction Documents obligating the Offeree User to purchase securities from or sell securities to each Offering User in accordance with the terms of each Offering by inputting data necessary to complete each set of such Transaction documents through form fields provided by the Forum Provider that correspond with the location in which such information shall be embedded on each set of Transaction Documents. The Offeree User shall input data through form fields provided by the Forum Provider, which shall correspond with the locations in which such information shall be embedded on the transaction documents associated with each offering and which shall be condensed to avoid duplication. Such data inputted by the Offeree User shall be electronically embedded in each set of Transaction Documents associated with the Offerings accepted under step 4 in the location that corresponds with the form field through which such data was submitted. Such data inputted shall include, but are not limited to, identification and contact information, number of securities to be purchased or sold, total purchase price of the subject securities to be purchased or sold, tax payer identification number, payment information and attestation that the Offeree User qualifies as an Accredited Investor (if necessary). In this manner, multiple sets of Transaction Documents can be embedded by each Offeree User using a single set of inputs and without the need to input duplicate data. In the alternative, such Transaction Documents may also be embedded with automatically generated information as provided by the Offeree User pursuant to Claim 1. The potential participating user will then be given the option to review the Transaction Documents, make corrections and verify that the information embedded is accurate.

The sixth step in creating the method and system contemplated in Claim 7 is the electronic authorization by the Offeree User of the legally binding Transaction Documents by affixing the electronic signature of such Offeree User in each location on each set of Transaction Documents where such electronic signature of the Offeree User is required. After the Transaction Documents have been embedded with information and reviewed for accuracy pursuant to step 5, the Offeree User shall embed an electronic signature authorizing the purchase or sale of securities by the Offeree User in accordance with the terms and conditions set forth in the Transaction Documents. The Offeree User may embed multiple sets of Transaction Documents using the same digital signature, thereby enabling such Offeree User to authorize multiple securities transactions simultaneously.

The seventh step in creating the method and system contemplated in Claim 7 is the transmission to each Offering User, for review, each respective set of Transaction Documents created pursuant to Step 5 of Claim 7 and authorized by the Offeree User in Step 6 of Claim 7. Based on review of the completed and authorized Transaction Documents, each Offering User can elect to proceed with the transaction underlying such Transaction Documents, inquire for more information using channels of communication provided by the present invention or void the transaction.

The eighth step in creating the method and system contemplated in Claim 7 is the electronic authorization by each Offering User of the legally binding Transaction Documents received pursuant to Step 7 of Claim 7 by affixing the electronic signature of such Offering Users in each location in the Transaction Documents where such electronic signature of each such respective Offering User is required. After each Offering User affixes its electronic signature to the Transaction Documents already authorized by the Offeree User, such securities transaction has been completed, subject to the settlement of the assets that are the subject of each set of Transaction Documents.

The ninth step in creating the method and system contemplated in Claim 6 is the electronic settlement of the purchase and/or sale of securities effectuated by the completed Transaction Documents by sending an order on behalf of each User purchasing securities as contemplated by the Transaction Documents each such User hereinafter referred to in this Claim as a “Purchasing User” or in multiples as “Purchasing Users”) to each Purchasing User's financial agent ordering such financial agent to electronically transfer funds from such Purchasing User's account in the amount set forth in each respective set of Transaction Documents to the account of each User selling securities as contemplated by the Transaction Documents (each such User hereinafter referred to in this Claim as a “Selling User” or in multiples as “Selling Users”) and/or to the accounts of such Selling User's agents and assigns as directed in the Transaction Documents, electronically sending an order on behalf of the Seller User to the Seller User's agent controlling the securities sold pursuant to the Offering to transfer such securities in the amount set forth in the Transaction Documents to the location for the receipt of delivery of the securities as directed in the Transaction Documents and sending electronic communications to the Offering User and the Offeree User confirming the transfer of assets and the completion of the sale of securities contemplated by the Transaction Documents. Purchasing Users shall provide to Forum Provider information regarding the means by which funds shall be transferred from the Purchasing User in satisfaction of Purchasing User's obligations in connection with the purchase of securities contemplated by the Transaction Documents, which may include but are not limited to credit card and debit card information, bank account information or wiring instructions, along with electronic authorization to transfer such funds, the location for the receipt of delivery of the securities, which may include the address of record of the Purchasing User, the Purchasing User's brokerage account or other location for which such securities shall be delivered and/or deposited and authorization for the electronic transfer of funds to the Selling User as set forth in the Transaction Documents. Selling Users shall provide to the Forum Provider information regarding the location where funds transferred from Purchasing User in connection with the purchase of the securities contemplated by the Transaction Documents shall be deposited, which may include bank account information or wire instructions, the location of the securities to be delivered to Purchasing User, such as Selling User's transfer agent, registrar, broker, legal counsel or other agent and electronic authorization directing such agent to issue and/or transfer the securities to the Purchasing User in accordance with the terms and conditions of the Transaction Documents.

What is claimed is:

1. A method and system of creating a series of interconnected technological forums to form a social network narrowly tailored to be used for the electronic dissemination of data regarding the private securities industry in compliance with the Securities Act, comprising the steps of:
i. the submission of information uploaded using the present invention to be stored on a server by a forum provider (hereinafter referred to as the “Forum Provider”) by users utilizing the present invention (each hereinafter referred to individually as a “User” or in multiples as “Users”) in accordance with instructions provided by the Forum Provider;
ii. assigning a digital tag (each hereinafter referred to individually as a “Tag” or in multiples as “Tags”) to be stored on a server or similar data storage device to each datum of information provided by Users in Step 1 of claim 1, either based on the recognition of the content of each datum of information, the form field through which the information was submitted or other such similar conditions as may be determined by the Forum Provider;
iii. creating unique user profiles (each hereinafter referred to individually as a “User Profile” or in multiples as “User Profiles”) which display data provided by Users in Step 1 of claim 1 about the User attributable to the User Profile and contain channels of communication through which other Users can electronically contact the User attributed to the User Profile or input information to be displayed on the User Profile;
iv. creating unique offering profiles (each hereinafter referred to individually as an “Offering Profile” or in multiples as “Offering Profiles”) which display data provided by Users in Step 1 of claim 1 about private offerings to purchase or sell securities (each hereinafter referred to individually as a “Offering” or in multiples as “Offerings”) and contain channels of communication through which other Users can electronically contact the User attributed to the Offering Profile or input information to be displayed on the Offering Profile; and
v. aggregating data provided by Users in Step 1 of claim 1 on the basis of Tags created in Step 2 of claim 1 to create a list of Users and/or Offerings in a publicly accessible central forum (hereinafter referred to as the “Central Forum”) that is organizable on the basis of Tags created in Step 2 of claim 1 whereby data provided by Users in Step 1 of claim 1 are displayed and bear a link to each corresponding User Profile or Offering Profile.

2. A method and system of electronically identifying Users who qualify as “Accredited Investors,” as defined in Regulation D of the Securities Act (17 CFR 230.501), in conjunction with the method and system claimed in claim 1, comprising the additional steps of:
i. the submission of information uploaded using the present invention to the Forum Provider by Users who desire to be identified as Accredited Investors indicating that said User desires to be identified as an Accredited Investor;
ii. assigning a digital Tag to be stored on a server or similar data storage device to each such User who submits information in accordance with Step 1 of claim 2 indicating that said User desires to be identified as an Accredited Investor; and
iii. displaying Tag indicating that such User who submits information in accordance with Step 1 of claim 2 has identified itself as an Accredited Investor on such User's User Profile and corresponding entry in the Central Forum.

3. A method and system of electronically providing the means for verifying Users that qualify as “Accredited Investors,” as defined in Regulation D of the Securities Act (17 CFR 230.501), in conjunction with the method and system claimed in claim 1 and claim 2, comprising the additional steps of:
i. the submission of one or more of the following documents, as applicable (hereinafter individually and collectively referred to herein as the “Accredited Investor Verification Documents”), uploaded using the present invention to the Forum Provider by Users who desire to be verified as Accredited Investors:
for verification of Accredited Investor status based on income, copies of any Internal Revenue Service form that reports income, such as Form W-2, Form 1099, Schedule K-1 of Form 1065, or a filed Form 1040;
for verification of Accredited Investor status based on net worth, specific types of documentation, dated within the prior three months, such as bank statements, brokerage statements, certificates of deposit, tax assessments and a credit report from at least one of the nationwide consumer reporting agencies, and obtaining a written representation from the investor;
for verification of Accredited Investor status based on attestation, a written confirmation from a registered broker-dealer, an SEC-registered investment adviser, a licensed attorney or a certified public accountant stating that such person or entity has taken reasonable steps to verify that the potential purchasing user is an Accredited Investor within the last three months and has determined that such purchaser is an Accredited Investor;
for verification of Accredited Investor status based on existing shareholder status, documentation verifying the accredited investor status of persons who had invested in an Issuer's Rule 506(b) offering as an Accredited Investor before Sep. 23, 2013 and remain investors of the issuer; and
any and all other documents upon which sellers or issuers of securities can rely, in compliance with the Securities Act and future amendments thereto, to verify that such Users who desire to be verified as Accredited Investors qualify as Accredited Investors.
ii. assigning a Tag to be stored on a server or similar data storage device to each such User who submits documentation in accordance with Step 1 of claim 3 indicating that said User is eligible to be verified as an Accredited Investor;
iii. displaying Tag indicating that such User who submits information in accordance with Step 1 of claim 3 is eligible to be verified as an Accredited Investor on such User's User Profile and corresponding entry in the Central Forum;
iv. the submission of authorization uploaded using the present invention to the Forum Provider by Users who have submitted Accredited Investor Verification Documents in accordance with Step 1 of claim 3 granting access to such User's Accredited Investor Verification Documents to other Users, either on the basis of express grants of access by such User attributable to such Accredited Investor Verification Documents to each other User or on another basis to be determined by such User attributable to such Accredited Investor Verification Documents; and
v. the transmission of Accredited Investor Verification Documents using the present invention to Users who have been granted access to such Accredited Investor Verification Documents in accordance with Step 4 of claim 3 by the User attributable to such Accredited Investor Verification Documents.

4. A method and system of electronically creating and disseminating general solicitations regarding Offerings, in conjunction with the method and system claimed in claim 1, comprising the additional steps of:
i. the submission of information to the Forum Provider by Users attributable to an Offering (hereinafter individually referred to as an “Offering User” or in multiples as “Offering Users”) containing information regarding such Offering to be electronically disseminated to other Users (hereinafter referred to individually as a “General Solicitation” or in multiples as “General Solicitations”) using the present invention;
ii. the submission of electronic authorization by Offering User to the Forum Provider granting access to other Users who are authorized to receive the General Solicitations created in Step 1 of claim 4, as determined either on the basis of Tags or on another basis to be determined by such Offering User; and
iii. the electronic transmission of General Solicitations using the present invention to Users who have been granted access to such General Solicitations by the Offering User pursuant to Step 2 of claim 4.

5. A method and system of electronically creating and settling private securities transactions using the present invention, in compliance with the Securities Act, directly between Users using general solicitations in connection with an Offering to sell securities, in conjunction with the method and system claimed in claim 1, claim 2, claim 3 and claim 4, comprising the additional steps of:
i. the submission by Users offering to sell securities pursuant to an Offering or otherwise (hereinafter referred to in this claim individually as an “Offering User” or in multiples as “Offering Users”) of all documents and information required to effectuate the sale and settlement of the securities offered for sale pursuant to such Offering (such documents, in addition to any similar documents provided by the Forum Provider or other third parties, collectively hereinafter referred to in this claim as the “Transaction Documents”) to the Forum Provider;
ii. processing the Transaction Documents provided in accordance with Step 1 of claim 5 so that such Transaction Documents could be electronically embedded with information inputted through form fields that correspond with the location in the Transaction Documents where such information shall be embedded;
iii. the submission of information by Users who elect to accept the offer to purchase securities offered for sale by the Offering User (each such User hereinafter referred to in this claim as the “Purchasing User” or in multiples as “Purchasing Users”) indicating acceptance of the offer to purchase the securities offered for sale by the Offering User through channels accessible through the Central Forum, the Offering User's User Profile or the Offering User's Offering Profile;
iv. the transmission to the Purchasing User, for review, the Transaction Documents submitted pursuant to Step 1 of claim 5.
v. the creation of legally binding Transaction Documents obligating Purchasing Users to purchase securities from the Offering User in accordance with the terms of the Offering by inputting data necessary to complete such transaction documents through form fields provided by the Forum Provider that correspond with the location in which such information shall be embedded on the Transaction Documents;
vi. the electronic authorization by the Purchasing User of the legally binding Transaction Documents created pursuant to Step 5 of claim 5 by affixing the electronic signature of such Purchasing User in each location in the Transaction Documents where such electronic signature of the Purchasing User is required;
vii. the transmission to the Offering User for review the Transaction Documents created pursuant to Step 5 of claim 5 and authorized by the Purchasing User in Step 6 of claim 5 and the Accredited Investor Verification Documents attributed to such Purchasing User submitted pursuant to claim 2.
viii. the electronic authorization by the Offering User of the legally binding Transaction Documents received pursuant to Step 7 of claim 5 by affixing the electronic signature of such Offering User in each location in the Transaction Documents where such electronic signature of the Offering User is required;
ix. the electronic settlement of the sale of securities effectuated by the Transaction Documents by electronically sending an order on behalf of the Purchasing User to the Purchasing User's financial agent ordering such financial agent to transfer funds from Purchasing User's account in the amount set forth in the Transaction Documents to Offering User's account and/or to the accounts of Offering User's agents and assigns as directed in the Transaction Documents, electronically sending an order on behalf of the Offering User to the agent controlling the securities sold pursuant to the Offering to transfer such securities in the amount set forth in the Transaction Documents to the location for the receipt of delivery of the securities as directed in the Transaction Documents and sending electronic communications to the Offering User and the Purchasing User confirming the completion of the sale of securities contemplated by the Transaction Documents.

6. A method and system of electronically creating and settling private securities transactions using the present invention, in compliance with the Securities Act, directly between Users using general solicitations in connection with an Offering to purchase securities, in conjunction with the method and system claimed in claim 1, claim 2, claim 3 and claim 4, comprising the additional steps of:
i. the submission by Users offering to purchase securities pursuant to an Offering or otherwise (hereinafter referred to in this claim individually as an “Offering User” or in multiples as “Offering Users”) of all documents and information, including Accredited Investor Verification Documents attributed to such Offering User as provided in accordance with claim 2 (if applicable), required to effectuate the purchase and settlement of the securities offered for purchase pursuant to such Offering (such documents, in addition to any similar documents provided by the Forum Provider or other third parties, collectively hereinafter referred to in this claim as the “Transaction Documents”) to the Forum Provider;
ii. processing the Transaction Documents provided in accordance with Step 1 of claim 6 so that such Transaction Documents could be electronically embedded with information inputted through form fields that correspond with the location in the Transaction Documents where such information shall be embedded;
iii. the submission of information by Users who elect to accept the offer to sell securities offered for purchase by the Offering User (each such User hereinafter referred to in this claim as the “Selling User” or in multiples as “Selling Users”) indicating acceptance of the offer to sell the securities offered for purchase by the Offering User through channels accessible through the Central Forum, the Offering User's User Profile or the Offering User's Offering Profile;
iv. the transmission to the Selling User, for review, the Transaction Documents submitted pursuant to Step 1 of claim 6.
v. the creation of legally binding Transaction Documents obligating Selling Users to sell securities to the Offering User in accordance with the terms of the Offering by inputting data necessary to complete such Transaction Documents through form fields provided by the Forum Provider that correspond with the location in which such information shall be embedded on the Transaction Documents;
vi. the electronic authorization by the Selling User of the legally binding Transaction Documents created pursuant to Step 5 of claim 6 by affixing the electronic signature of such Selling User in each location in the Transaction Documents where such electronic signature of the Selling User is required;
vii. the transmission to the Offering User for review the Transaction Documents created pursuant to Step 5 of claim 6 and authorized by the Selling User in Step 6 of claim 6.
viii. the electronic authorization by the Offering User of the legally binding Transaction Documents received pursuant to Step 7 of claim 6 by affixing the electronic signature of such Offering User in each location in the Transaction Documents where such electronic signature of the Offering User is required;
ix. the electronic settlement of the sale of securities effectuated by the Transaction Documents by electronically sending an order on behalf of the Offering User to the Offering User's financial agent ordering such financial agent to transfer funds from Offering User's account in the amount set forth in the Transaction Documents to Selling User's account and/or to the accounts of Selling User's agents and assigns as directed in the Transaction Documents, electronically sending an order on behalf of the Selling User to the Selling User's agent controlling the securities sold pursuant to the Offering to transfer such securities in the amount set forth in the Transaction Documents to the location for the receipt of delivery of the securities as directed in the Transaction Documents and sending electronic communications to the Offering User and the Selling User confirming the transfer of assets and the completion of the sale of securities contemplated by the Transaction Documents.

7. A method and system of electronically creating and settling multiple sets of private securities transactions using the present invention, in compliance with the Securities Act, directly between Users using general solicitations in connection with Offerings to purchase or sell securities, in conjunction with the method and system claimed in claims 1, claim 2, claim 3, claim 4, claim 5 and claim 6, comprising the additional steps of:
i. displaying of data regarding Offerings to purchase or sell securities, in accordance with claim 2 and claim 3, either viewed as a list of Offerings that are aggregated and organized in the Central Form or viewed individually through an Offering Profile or through the User Profile of the User attributable to the Offering (each such User hereinafter referred to in this claim individually as an “Offering User” or in multiples as “Offering Users”).
ii. applying Tags to one or more Offerings by a User that desires to purchase and/or sell securities in accordance with the terms of such Offerings (each such User hereinafter referred to in this claim individually as an “Offeree User” or in multiples as “Offeree Users”), either by manually applying Tags to each Offering or by automatically applying Tags using inputs provided by the Offeree User to the Forum Provider indicating the preferences for which Offerings the Offeree User desires to be tagged;
iii. displaying the Offerings to which the Offeree User has applied Tags on a webpage that allows such Offeree User, at minimum, to indicate the number of securities to be sold or purchased for each Offering tagged in accordance with Step 2 of claim 7, remove Offerings from the list of Offerings desired to be accepted by such Offeree User, view the potential allocation of assets after consummation of the transactions contemplated by the Offerings and receive any information or documentation made publicly available by each Offering User, including but not limited to those Transaction Documents submitted to the Forum Provider pursuant to Step 1 of claim 5 and Step 1 of claim 6 by each Offering User (such documents, in addition to any similar documents provided by the Forum Provider or other third parties, collectively hereinafter referred to in this claim as the “Transaction Documents”), in connection with the Offerings that the Offeree User has applied a Tag.
iv. the submission of information by the Offeree User indicating acceptance of the offers underlying the Offerings tagged by the Offeree User;
v. the creation of legally binding Transaction Documents obligating the Offeree User to purchase securities from or sell securities to each Offering User in accordance with the terms of each Offering by inputting data necessary to complete each set of such Transaction documents through form fields provided by the Forum Provider that correspond with the location in which such information shall be embedded on each set of Transaction Documents;
vi. the electronic authorization by the Offeree User of the legally binding Transaction Documents by affixing the electronic signature of such Offeree User in each location on each set of Transaction Documents where such electronic signature of the Offeree User is required;
vii. the transmission to each Offering User, for review, each respective set of Transaction Documents created pursuant to Step 5 of claim 7 and authorized by the Offeree User in Step 6 of claim 7;
viii. the electronic authorization by each Offering User of the legally binding Transaction Documents received pursuant to Step 7 of claim 7 by affixing the electronic signature of such Offering Users in each location in the Transaction Documents where such electronic signature of each such respective Offering User is required;
ix. the electronic settlement of the purchase and/or sale of securities effectuated by the completed Transaction Documents by sending an order on behalf of each User purchasing securities as contemplated by the Transaction Documents each such User hereinafter referred to in this claim as a “Purchasing User” or in multiples as “Purchasing Users”) to each Purchasing User's financial agent ordering such financial agent to electronically transfer funds from such Purchasing User's account in the amount set forth in each respective set of Transaction Documents to the account of each User selling securities as contemplated by the Transaction Documents (each such User hereinafter referred to in this claim as a “Selling User” or in multiples as “Selling Users”) and/or to the accounts of such Selling User's agents and assigns as directed in the Transaction Documents, electronically sending an order on behalf of the Seller User to the Seller User's agent controlling the securities sold pursuant to the Offering to transfer such securities in the amount set forth in the Transaction Documents to the location for the receipt of delivery of the securities as directed in the Transaction Documents and sending electronic communications to the Offering User and the Offeree User confirming the transfer of assets and the completion of the sale of securities contemplated by the Transaction Documents.
